(19) United States
(12) Patent Application Publication
(10) Pub. No.: US 2019/0310813 A1
(43) Pub. Date: Oct. 10, 2019

(54) IMAGE FORMING APPARATUS, CONTROL METHOD OF IMAGE FORMING APPARATUS AND STORAGE MEDIUM

(71) Applicant: CANON KABUSHIKI KAISHA, Tokyo (JP)

(72) Inventors: Tomohide Kubota, Kawasaki-shi (JP); Tatsunori Suzuki, Toride-shi (JP)

(21) Appl. No.: 16/367,468

(22) Filed: Mar. 28, 2019

(30) Foreign Application Priority Data
Apr. 4, 2018 (JP) 2018-072497

(51) Int. Cl. G06F 3/12

(52) U.S. Cl. CPC G06F 3/1238; G06F 3/1253; G06F 3/125

(57) ABSTRACT

It is possible to efficiently perform preceding rendering processing performed before printing instructions in accordance with the necessity in a hold printing. The image forming apparatus according to the present invention is an image forming apparatus capable of performing hold printing, the image forming apparatus performs preceding processing to perform in advance rendering for image data of a held print job before reception of printing instructions, saves a rendering image generated by the preceding processing in a storage apparatus, and determines whether or not it is possible to save a new rendering image in the storage apparatus before the preceding processing is performed, and whether or not to perform the preceding processing is determined in accordance with determination results.

### BACKGROUND OF THE INVENTION

### Field of the Invention

The present invention relates to an image forming apparatus capable of performing hold printing in which a print job is held temporarily.

### Description of the Related Art

In recent years, as a network environment spreads, it becomes common for a plurality of users to make use of an image forming apparatus in a sharing manner. Accompanying this, a request for a technique is increasing, which guarantees security of printed matter or the like with high confidentiality by preventing the printed matter from being seen by another user at the time of outputting the printed matter. As a method that responds to such a request, for example, there is a printing method in which a print job is held within the image forming apparatus and printing is performed after user authentication (hereinafter, called hold printing) (Japanese Patent Laid-Open No. 2006-099714).

In the hold printing as described in Japanese Patent Laid-Open No. 2006-099714, in a case where printing instructions from a user via the operation screen of the image forming apparatus are received, rendering processing of a held print job is started. Because of this, there is a possibility that a user is caused to wait in front of the image forming apparatus. Consequently, in order to reduce the wait time such as this, a method has been proposed in which rendering processing of a held print job is performed in advance before receiving printing instructions from a user (hereinafter, called preceding rendering processing).

However, in a case where the preceding rendering processing is performed, it is necessary to save image data generated by the preceding rendering processing in the storage apparatus of the image forming apparatus until printing instructions are received. Consequently, in a case where many print jobs are input or the like, there is a possibility that the capacity of the storage apparatus of the image forming apparatus runs short because of the image data of those print jobs. Further, in such a case, there is a possibility that it is not possible to save the generated image data in the storage apparatus even though the preceding rendering processing is performed, and therefore, the preceding rendering processing itself becomes wasteful.

Consequently, an object of the present invention is to provide an image forming apparatus capable of efficiently performing preceding rendering processing performed in advance before printing instructions in accordance with the necessity in hold printing.

### SUMMARY OF THE INVENTION

The image forming apparatus according to the present invention is an image forming apparatus capable of performing hold printing in which a received print job is held and printing of a held print job is performed in accordance with printing instructions from a user, and the image forming apparatus includes: one or more memories storing instructions; and one or more processors which is capable of executing the instructions causing the image forming apparatus to: perform preceding processing to perform in advance rendering for image data of the held print job before reception of printing instructions; save a rendering image generated by the preceding processing in a storage apparatus; and determine whether or not it is possible to save a new rendering image in the storage apparatus before the preceding processing is performed, and whether or not to perform the preceding processing is determined in accordance with determination results.

Further features of the present invention will become apparent from the following description of exemplary embodiments with reference to the attached drawings.

### BRIEF DESCRIPTION OF THE DRAWINGS

FIG. 1A and FIG. 1B are diagrams showing an example of a configuration of a printing system;

FIG. 2 is a diagram showing an example of a sequence in a first embodiment at the time of the printing system receiving a print job from a PC;

FIGS. 3A to FIG. 3D are diagrams for explaining hold printing processing performed by a controller included in an image forming apparatus of the first embodiment;

FIG. 4A to FIG. 4C are diagrams for explaining preceding processing performed by the controller included in the image forming apparatus of the first embodiment;

FIG. 5 is a flowchart showing print execution processing performed by the controller included in the image forming apparatus of the first embodiment;

FIG. 6 is a diagram showing an example of a UI screen displaying a list of held print jobs;

FIG. 7 is a flowchart showing addition processing of preceding processing results performed by the controller included in the image forming apparatus of the first embodiment;

FIG. 8 is a diagram explaining an example of information on preceding processing results added to PDL data by the addition processing of preceding processing results;

FIG. 9 is a diagram showing the relationship of FIG. 9A and FIG. 9B;

FIG. 9A is a flowchart showing an example of finishing rendering processing performed by the controller included in the image forming apparatus of the first embodiment;

FIG. 9B is a flowchart showing an example of finishing rendering processing performed by the controller included in the image forming apparatus of the first embodiment;

FIG. 10A to FIG. 10C are diagrams for explaining the finishing rendering processing;

FIG. 11 is a diagram showing an example of a sequence in a second embodiment at the time of a printing system receiving a print job from a PC;

FIG. 12A is a diagram showing the relationship of FIG. 12A-1 and FIG. 12A-2;

FIG. 12A-1, FIG. 12A-2 and FIG. 12B are diagrams for explaining preceding processing performed by a controller included in an image forming apparatus of the second embodiment;

FIG. 13 is a diagram showing an example of a sequence in a third embodiment at the time of a printing system receiving a print job from a PC;

FIG. 14A is a diagram showing the relationship of FIG. 14A-1 and FIG. 14A-2;

FIG. 14A-1, FIG. 14A-2 and FIG. 14B are diagrams for explaining preceding processing performed by a controller included in an image forming apparatus of the third embodiment;

FIG. 15 is a diagram showing the relationship of FIG. 15A and FIG. 15B;

FIG. 15A is a diagram showing an example of a sequence in a fourth embodiment at the time of a printing system receiving a print job from a PC;

FIG. 15B is a diagram showing an example of a sequence in a fourth embodiment at the time of a printing system receiving a print job from a PC;

FIG. 16A is a diagram showing the relationship of FIG. 16A-1 and FIG. 16A-2;

FIG. 16A-1, FIG. 16A-2 and FIG. 16B are diagrams for explaining preceding processing performed by a controller included in an image forming apparatus of the fourth embodiment;

FIG. 17 is a flowchart showing an example of print execution processing performed by the controller included in the image forming apparatus of the fourth embodiment;

FIG. 18 is a flowchart showing an example of addition processing of preceding processing results performed by the controller included in the image forming apparatus of the fourth embodiment;

FIG. 19 is a diagram showing the relationship of FIG. 19A and FIG. 19B;

FIG. 19A is a flowchart showing an example of acquisition processing of a preceding processing image performed by the controller included in the image forming apparatus of the fourth embodiment;

FIG. 19B is a flowchart showing an example of acquisition processing of a preceding processing image performed by the controller included in the image forming apparatus of the fourth embodiment;

FIG. 20 is a diagram showing the relationship of FIG. 20A and FIG. 20B;

FIG. 20A is a diagram showing an example of a sequence in a fifth embodiment at the time of a printing system receiving a print job from a PC;

FIG. 20B is a diagram showing an example of a sequence in a fifth embodiment at the time of a printing system receiving a print job from a PC;

FIG. 21 is a diagram showing the relationship of FIG. 21A and FIG. 21B;

FIG. 21A is a flowchart showing an example of preceding processing performed by a controller included in an image forming apparatus of the fifth embodiment;

FIG. 21B is a flowchart showing an example of preceding processing performed by a controller included in an image forming apparatus of the fifth embodiment;

FIG. 22 is a diagram showing the relationship of FIG. 22A and FIG. 22B;

FIG. 22A is a flowchart showing an example of finishing rendering processing performed by the controller included in the image forming apparatus of the fifth embodiment;

FIG. 22B is a flowchart showing an example of finishing rendering processing performed by the controller included in the image forming apparatus of the fifth embodiment; and

FIG. 23 is a flowchart showing an example of acquisition processing of a preceding processing image performed by the controller included in the image forming apparatus of the fifth embodiment.

### DESCRIPTION OF THE EMBODIMENTS

In the following, aspects for embodying the present invention are explained by using the drawings. In each drawing, the same reference number is attached to the same component and repeated explanation is omitted.

In each embodiment shown below, received print data is saved and before printing instructions from a user are input, preceding rendering processing is performed in which processing is performed for at least a part of pages of the print data and rendering is performed in advance for image data corresponding to the pages. Hereinafter, preceding rendering processing is called simply preceding processing. In a first embodiment, an image forming apparatus is explained, which determines whether or not it is possible to perform preceding processing in accordance with the remaining amount of a storage apparatus. In a second embodiment and a third embodiment, an image forming apparatus is explained, which deletes results of preceding processing already saved in a storage apparatus in accordance with the remaining amount of the storage apparatus and saves results of preceding processing performed anew. In a fourth embodiment and a fifth embodiment, an image forming apparatus is explained, which transfers results of preceding processing to another image forming apparatus in accordance with the remaining amount of a storage apparatus possessed by another forming device located on a network.

### First Embodiment

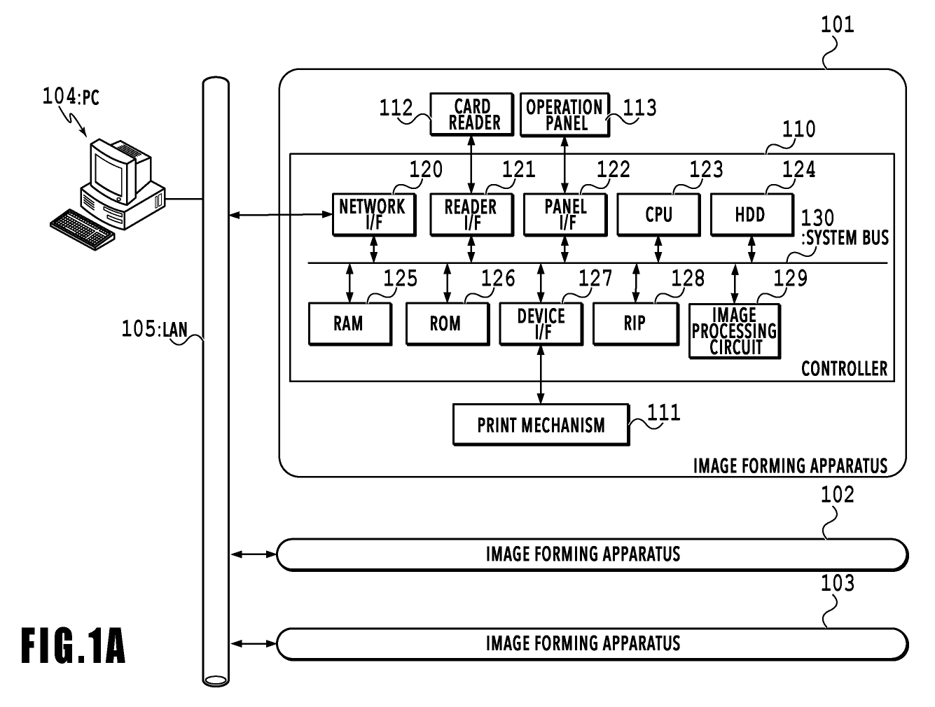

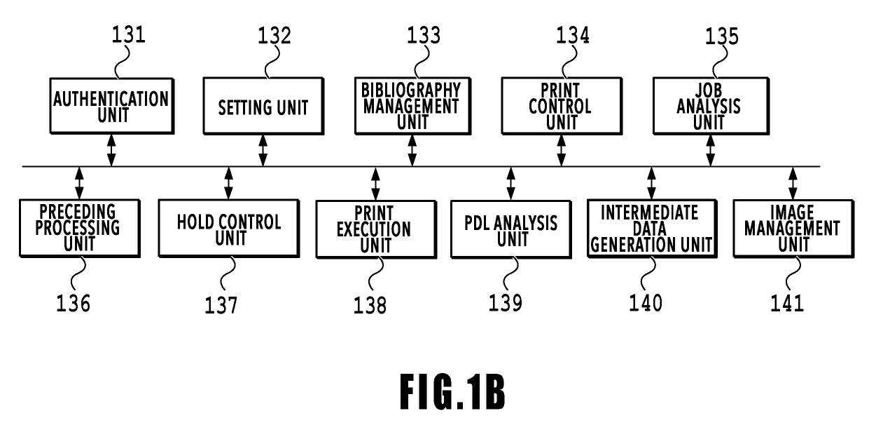

FIG. 1A and FIG. 1B are diagrams showing an example of a configuration of a printing system. Each of image forming apparatuses 101 to 103 shown in FIG. 1A is, for example, an MFP (Multi Function Printer), an SFP (Single Function Printer), or an LBP (Laser Beam Printer). Each of the image forming apparatuses 101 to 103 may be a printer other than the MFP, SFP, and LBP. Further, in FIG. 1A, three image forming apparatuses are shown, but it may also be possible for the printing system to include any number of image forming apparatuses.

The image forming apparatuses 101 to 103 are connected with a personal computer (PC) 104 that gives various instructions via a LAN (Local Area Network) 105, such as Ethernet. The image forming apparatuses 101 to 103 perform processing in accordance with printing instructions from the PC 104. Further, as shown in FIG. 1A, in a case where a plurality of image forming apparatuses is connected via the LAN 105, it is possible for the image forming apparatus to receive a print job from another image forming apparatus and to perform printing processing in accordance with the received print job.

The image forming apparatus 101 includes a controller 110, a print mechanism 111, a card reader 112, and an operation panel 113. The configuration of the image forming apparatuses 102 and 103 is the same as that of the image forming apparatus 101, and therefore, explanation is omitted.

The controller 110 controls the entire image forming apparatus 101 in accordance with programs stored in a ROM 126. The controller 110 has a network I/F 120, a reader I/F 121, a panel I/F 122, a CPU 123, an HDD (Hard Disk Drive) 124, a RAM 125, and the ROM 126. Further, the controller 110 has a device I/F 127, a RIP (Raster Image Processor) 128, and an image processing circuit 129. Each of these components is connect to one another via a system bus 130. The network I/F 120 is, for example, a LAN card. The network I/F 120 connects to the LAN 105 and performs input and output of information with an external device. The reader I/F 121 is connected with the card reader 112, and receives information input via the card reader 112 and delivers the information to the CPU 123. The card reader 112 reads information (for example, user information and authentication information) from an ID card or the like and notifies the controller 110 of the read information via the reader I/F 121. The panel I/F 122 is connected with the operation panel 113. The operation panel 113 is implemented by, for example, a liquid crystal display or the like having a touch panel function. The panel I/F 122 receives screen information for displaying various menus, information on a print job, and so on and screen information for displaying an operation screen and outputs them to the operation panel 113. Further, the panel I/F 122 receives operation information input by a user via the operation panel 113 and delivers the operation information to the CPU 123. The CPU 123 is a central processing unit configured to control the entire image forming apparatus 101. The HDD 124 stores system software for various kinds of processing, print jobs, image data, and so on. In place of the HDD 124 or in addition to the HDD 124, it may also be possible to include an SSD (Solid State Drive) and a USB (Universe Serial Bus) memory. Further, in place of the HDD 124 or in addition to the HDD 124, it may also be possible to include a storage apparatus, for example, a storage medium, such as an SD card, an implementation-type memory, such as an eMMC (embedded MultiMedia Card). The RAM 125 is a system work memory for the CPU 123 to operate. The RAM 125 is also made use of as an image memory for temporarily storing a print job and image data. The ROM 126 is a boot ROM and in the ROM 126, a boot program for booting the system is stored. The device I/F 127 connects the print mechanism 111 and the controller 110 and performs synchronous/asynchronous conversion of image data. The RIP 128 analyzes intermediate data (display list (DL)) and develops the intermediate data into an image. The image processing circuit 129 performs processing, such as correction and resolution conversion, in accordance with the print mechanism 111 for image data generated by analyzing a print job.

FIG. 1B shows an example of a software configuration of the controller 110 that controls the operation of the image forming apparatuses 101 to 103. The controller 110 includes an authentication unit 131, a setting unit 132, a bibliography management unit 133, a print control unit 134, a job analysis unit 135, a preceding processing unit 136, a hold control unit 137, a print execution unit 138, a PDL analysis unit 139, an intermediate data generation unit 140, and an image management unit 141. Each of the units 131 to 141 is implemented by programs stored in the hardware, such as the CPU 123, the RAM 125, and the HDD 124, and in the ROM 126. The authentication unit 131 delivers authentication information received from the reader I/F 121 via the system bus 130 to the hold control unit 137. The setting unit 132 receives information input to the operation panel 113 through the panel I/F 122 and the system bus 130, outputs information to the operation unit 113, and so on. The bibliography management unit 133 manages information relating to a print job received by the hold control unit 137. The print control unit 134 acquires printing instructions and a print job input through the network I/F 120 and instructs the hold control unit 137 and the print execution unit 138 to perform processing for the print job. The job analysis unit 135 preforms an analysis of the print job received by the hold control unit 137. The preceding processing unit 136 performs rendering processing for the print job in advance. Hereinafter, this rendering processing is called preceding processing. Further, the image data obtained by the preceding processing is called preceding processing image. The hold control unit 137 manages the print job received from the print control unit 134, controls the preceding processing, instructs the print execution unit 138 to perform printing, and so on. The print execution unit 138 generates image data by controlling the PDL analysis unit 139, the intermediate data generation unit 140, the RIP 128, and the image processing circuit 129 in response to the instructions from the print control unit 134 and the hold control unit 137. Further, the print execution unit 138 causes the print mechanism 111 to perform printing processing for the generated image data through the device I/F 127. The PDL analysis unit 139 performs a PLD analysis of the print job for which instructions are given from the print execution unit 138. PDL is an abbreviation of Page Description Language. The intermediate data generation unit 140 generates intermediate data based on the information analyzed by the PDL analysis unit 139. The image management unit 141 manages and stores the rendering image (preceding processing image) generated by the preceding processing unit 136. Further, the image management unit 141 determines where there is a sufficient capacity in the storage apparatus, such as the HDD 124, in a case of storing the rendering image and on a condition that the capacity is not enough, the image management unit 141 performs a predetermined operation for securing the capacity of the storage apparatus.

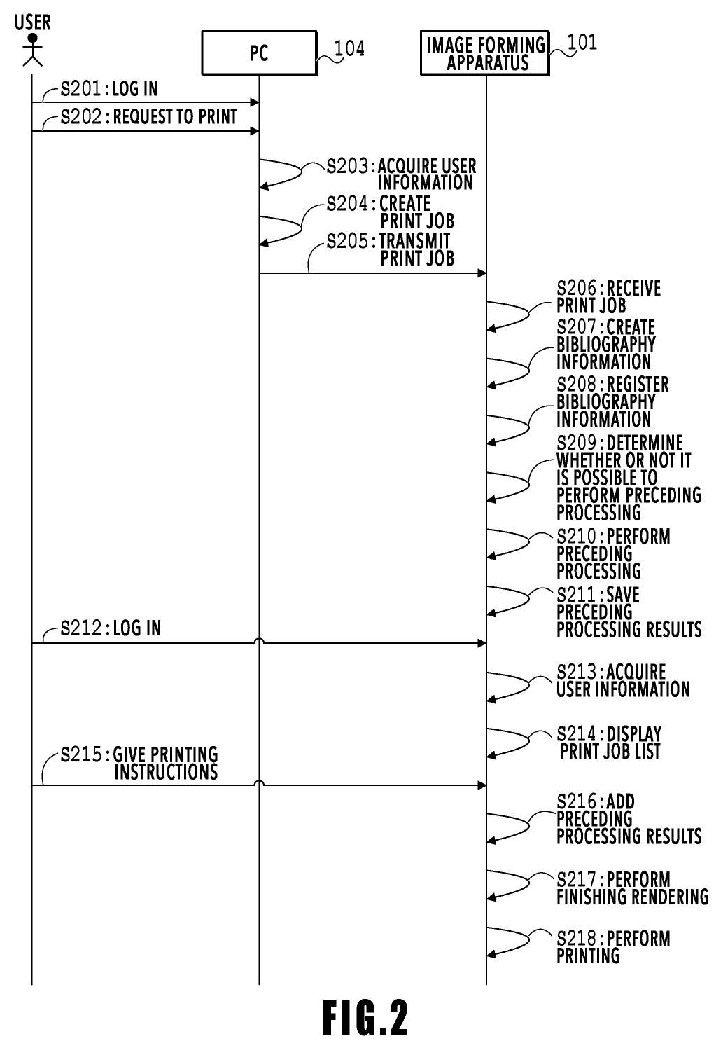

FIG. 2 is a diagram showing an example of a sequence in the first embodiment at the time of the printing system receiving a print job from the PC 104. In FIG. 2, for simplification of the drawing, the image forming apparatuses 102 and 103 are omitted. First, a user logs in to the PC 104 (step S201). Hereinafter, “step S201” is simply described as “S201”. This also applies to the other steps. Then, the user requests printing of data from an arbitrary application installed in the PC 104 (S202). The PC 104 acquires the user information input by the user at the time of log-in (S203). Then, the PC 104 adds the acquired user information to the print job and transmits the print job to the image forming apparatus 101 (S205). Upon receipt of the print job, the image forming apparatus 101 saves the print job in the HDD 124 (S206). Then, the image forming apparatus 101 extracts the user information added to the print job, creates bibliography information on the print job (S207), and saves the created bibliography information in the HDD 124 in association with the user information (S208). The image forming apparatus 101 starts preceding processing after saving the bibliography information. However, before starting the preceding processing, the image forming apparatus 101 determines whether or not it is possible to perform the preceding processing, more specifically, determines whether or not it is possible to save results of the preceding processing (preceding processing image) in the HDD 124 (S209). In a case of determining that it is possible to perform the preceding processing, the image forming apparatus 101 performs the preceding processing (S210) and saves the preceding processing image generated by the preceding processing in the HDD 124 (S211).

In a case where the user logs in to the image forming apparatus 101 (S212), the image forming apparatus 101 acquires the user information input by the user at the time of log-in (S213) and displays a print job list of the user on the operation panel 113 (S214). Upon receipt of printing instructions from a user (S215), the image forming apparatus 101 adds the preceding processing image saved in the HDD 124 to the print job (S216). The image forming apparatus 101 performs rendering processing by using the preceding processing image added to the print job (S217) and performs printing (S218). The rendering processing performed after the reception of the printing instructions is represented as finishing rendering processing.

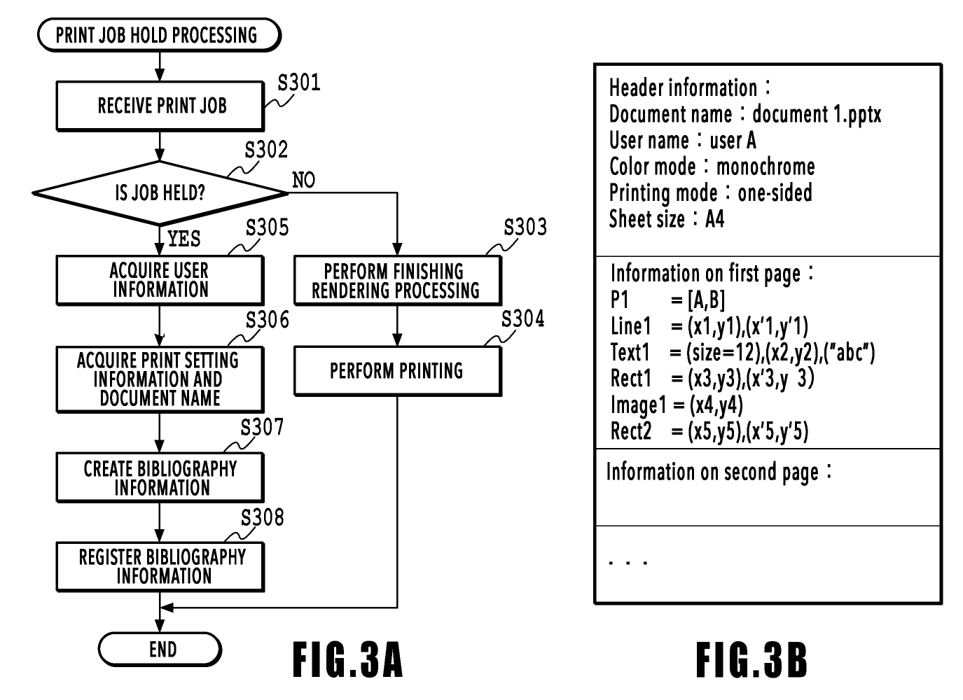

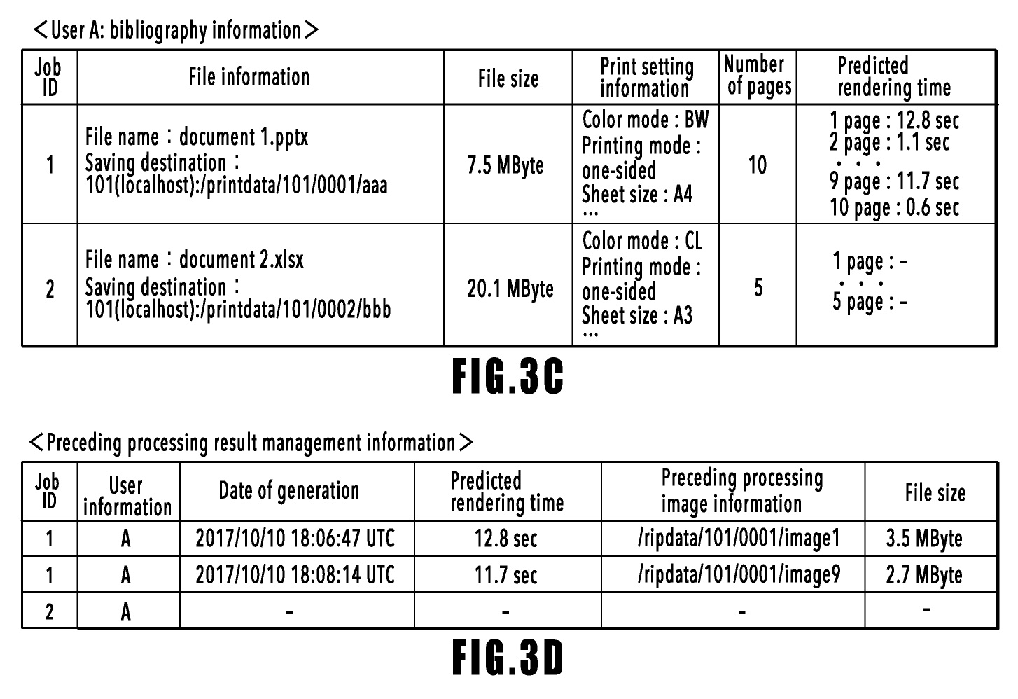

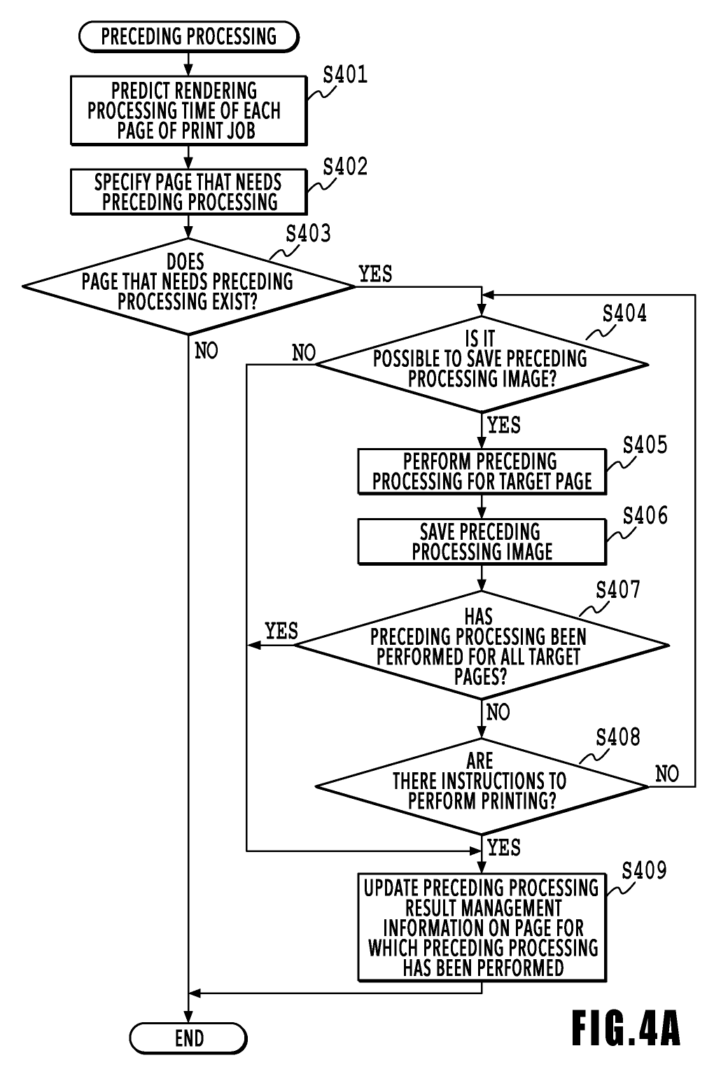

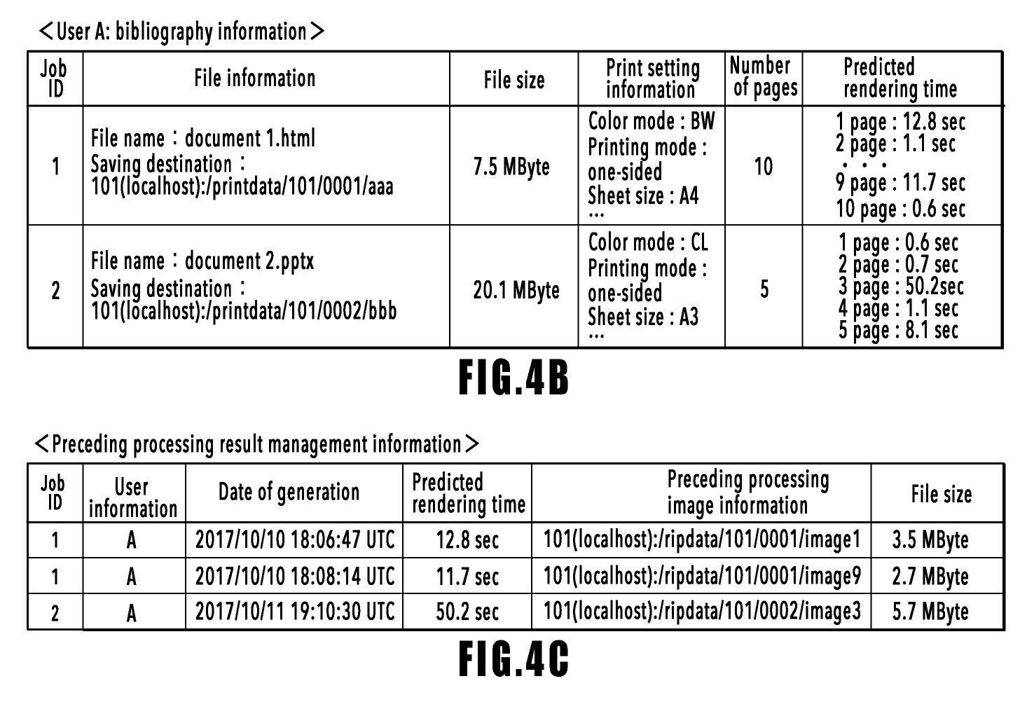

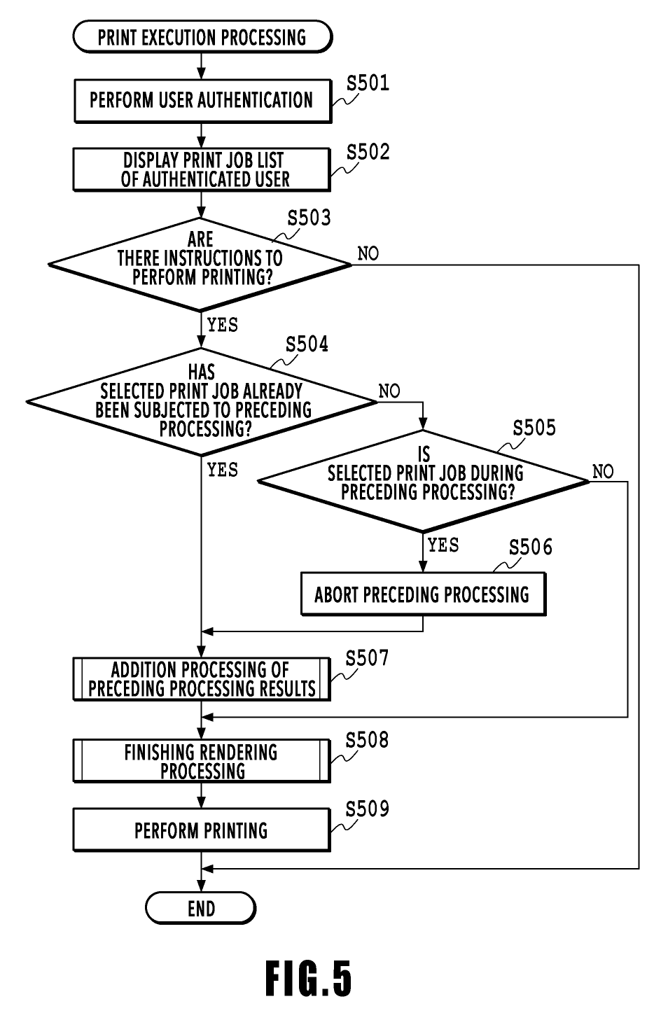

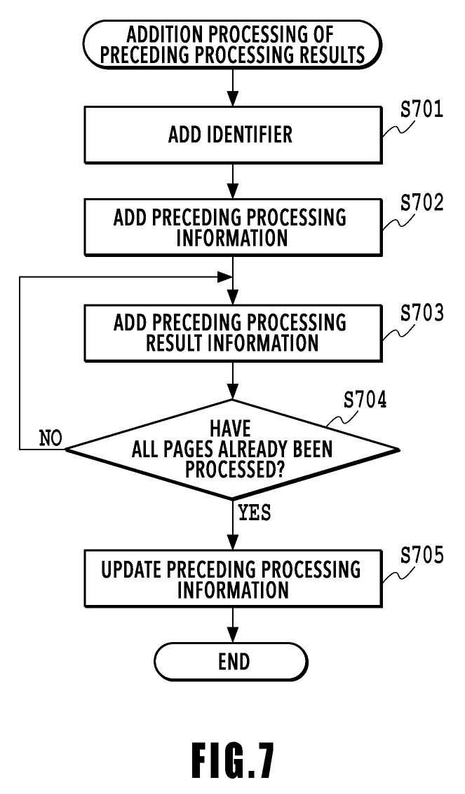

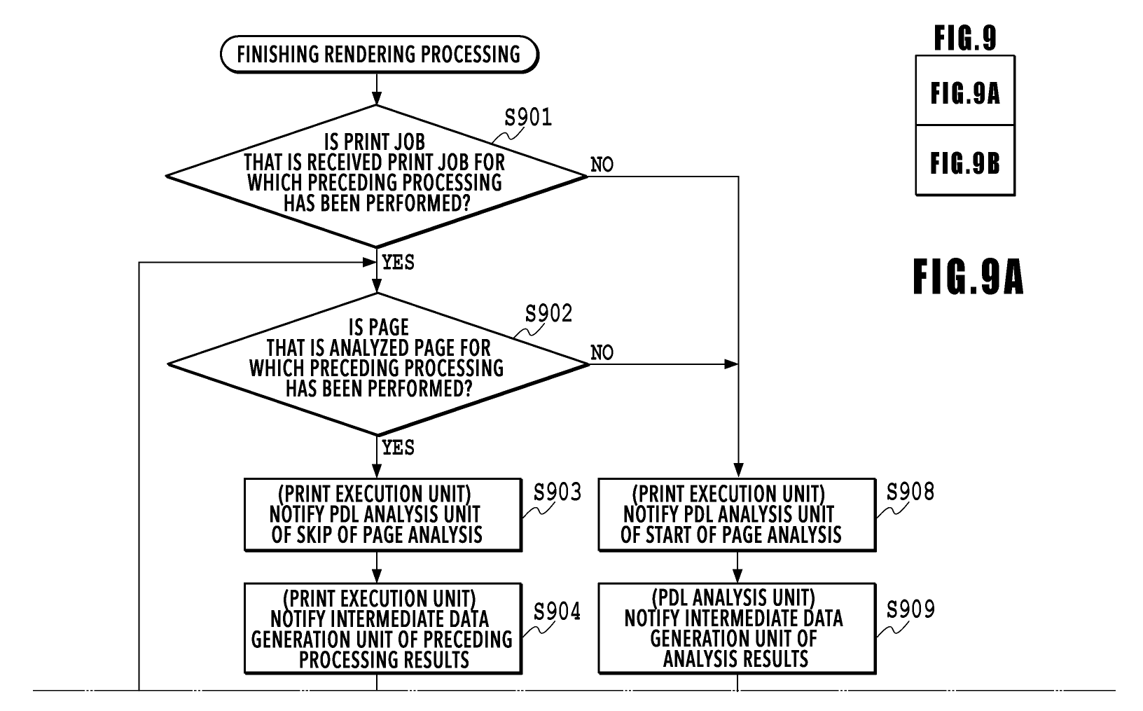

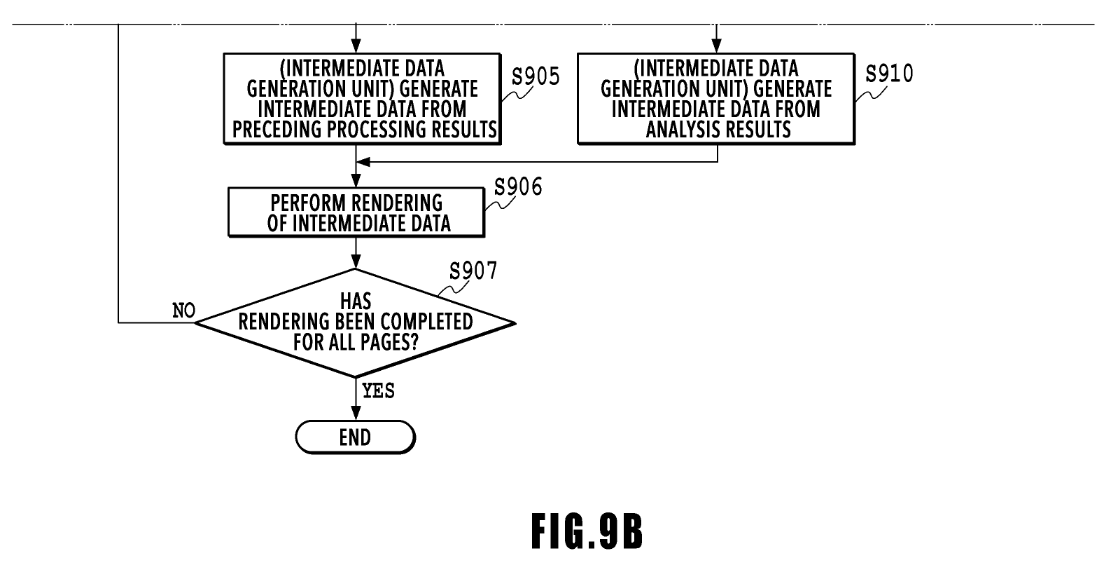

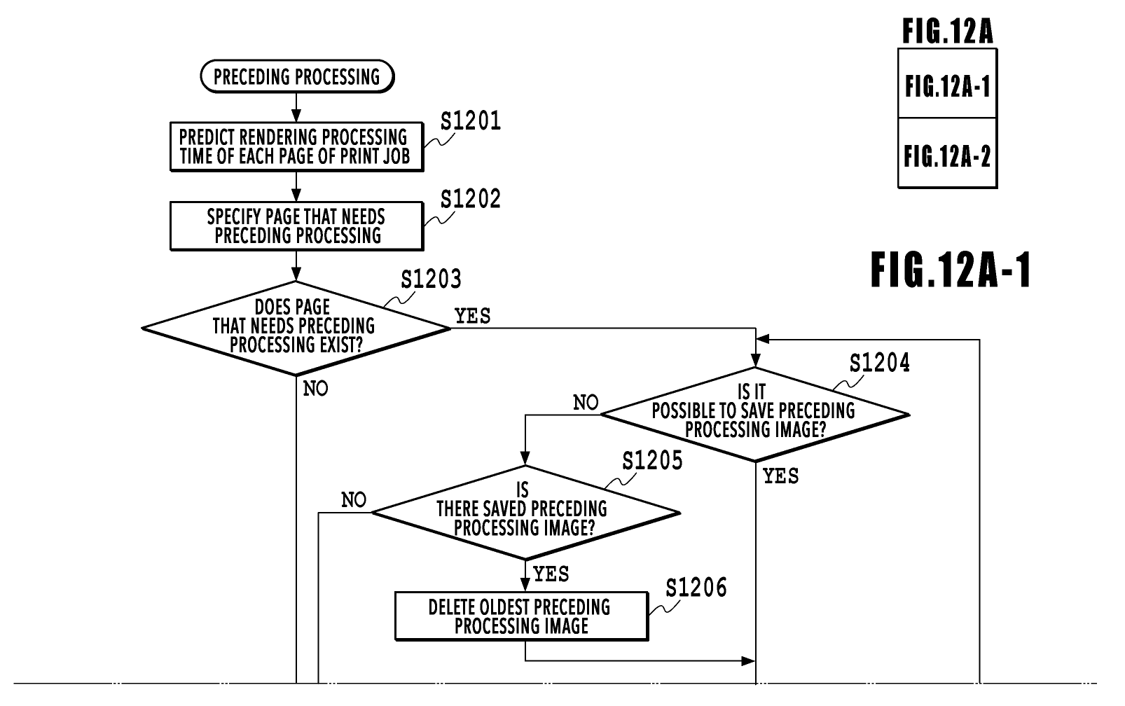

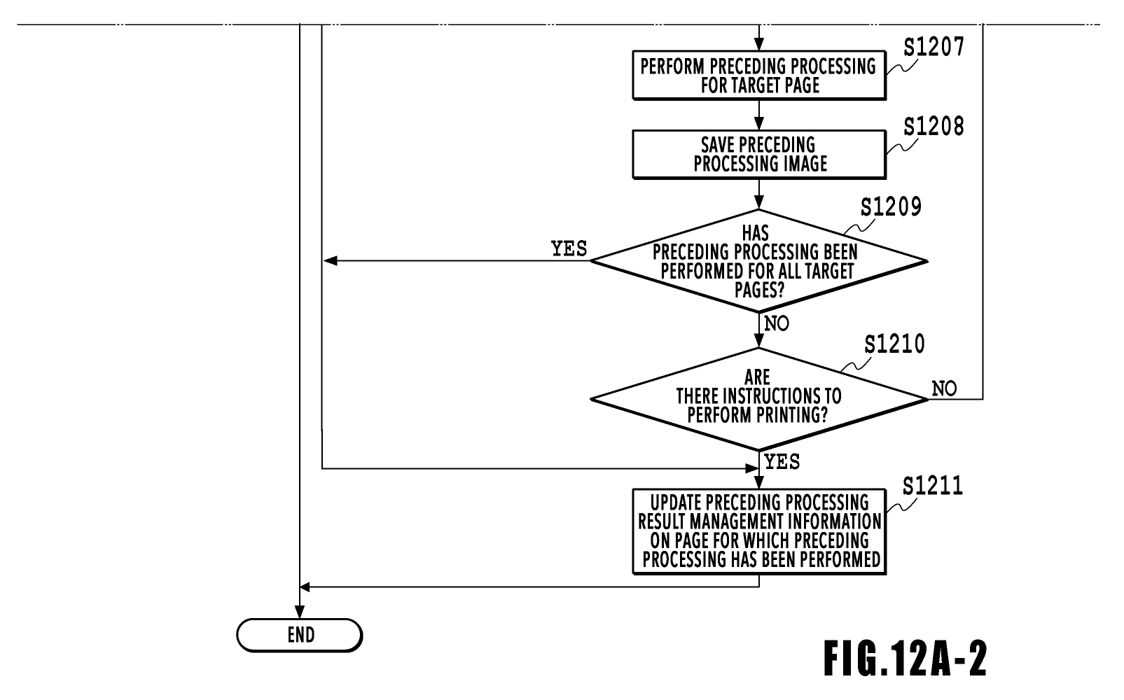

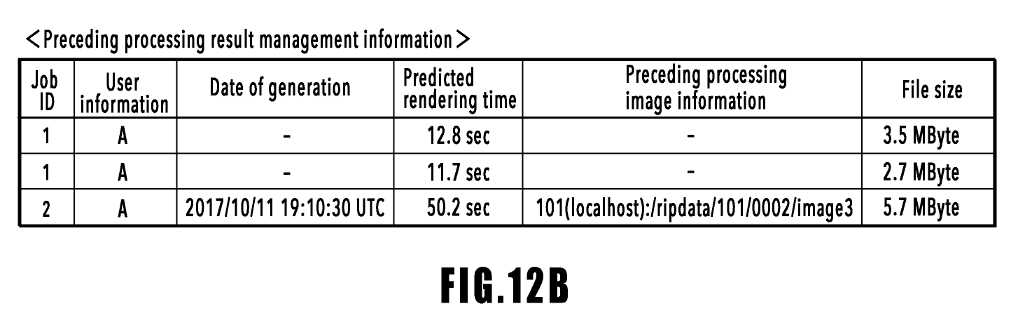

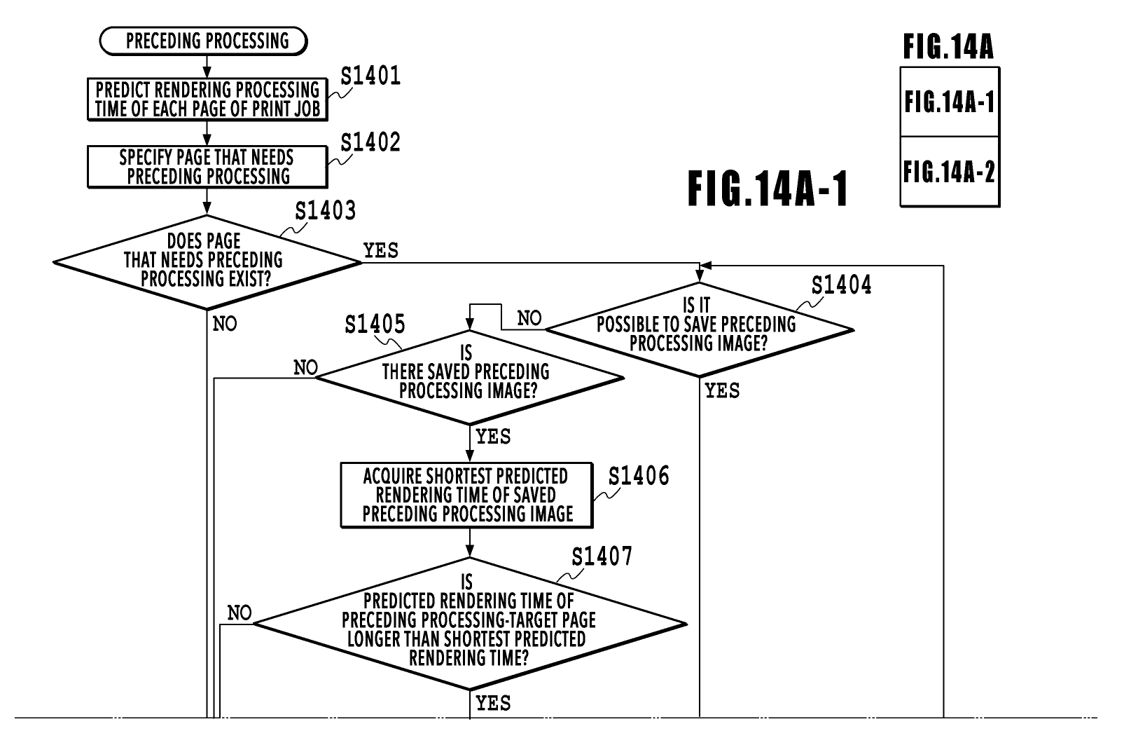

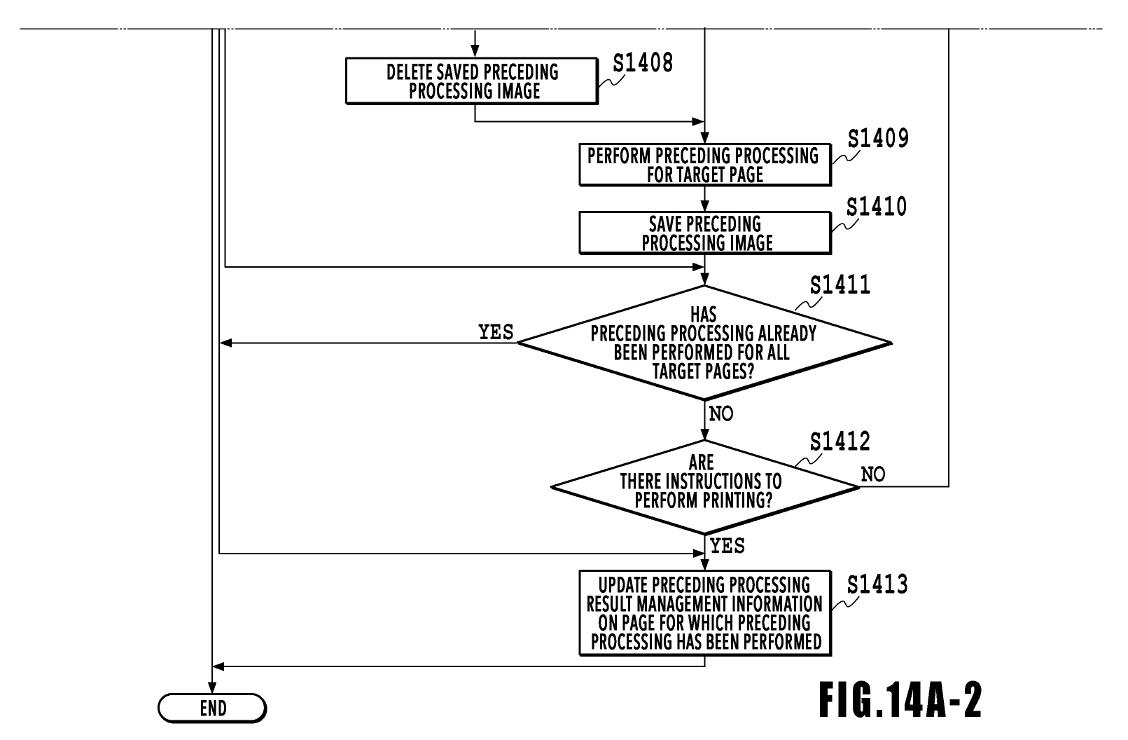

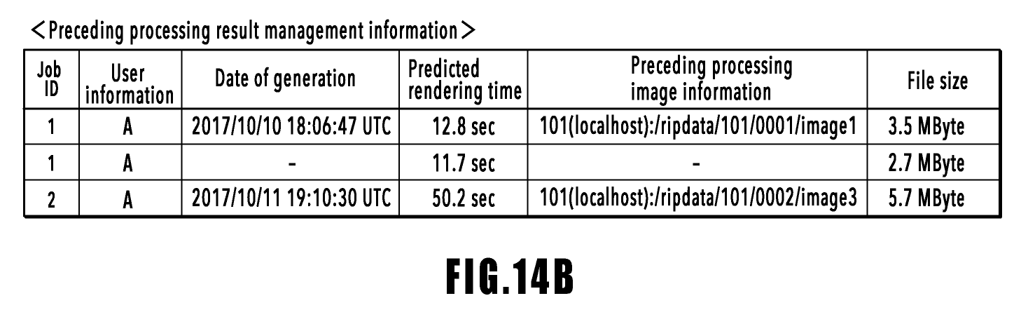

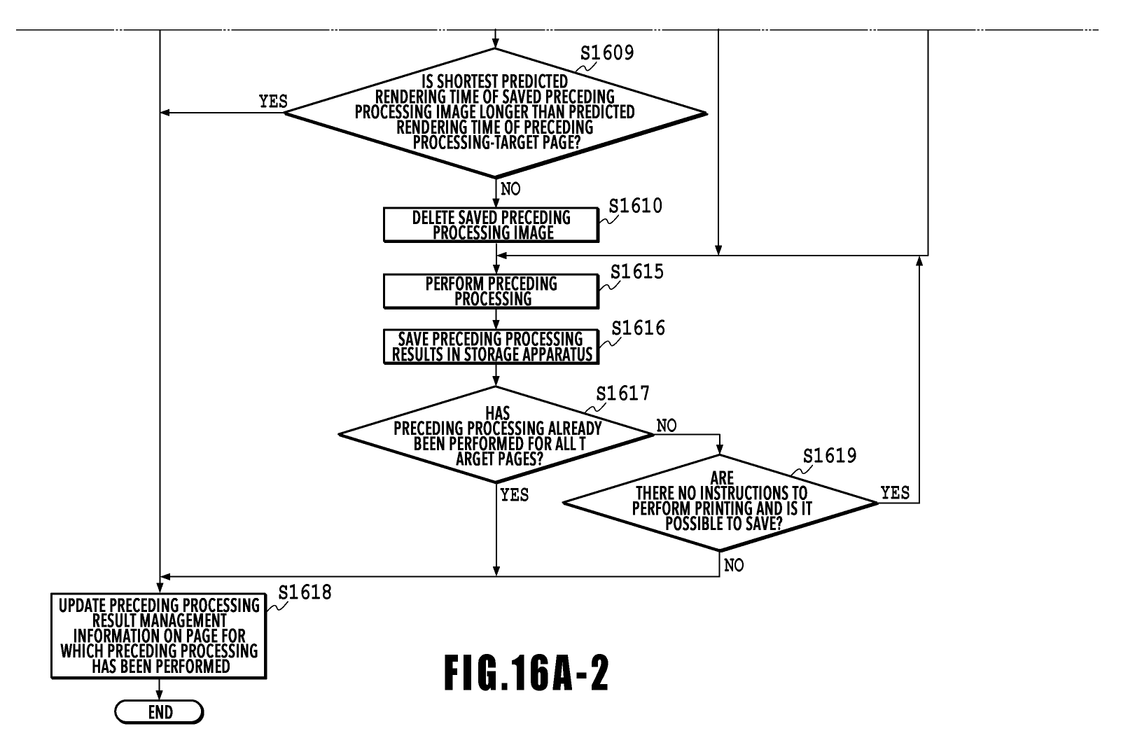

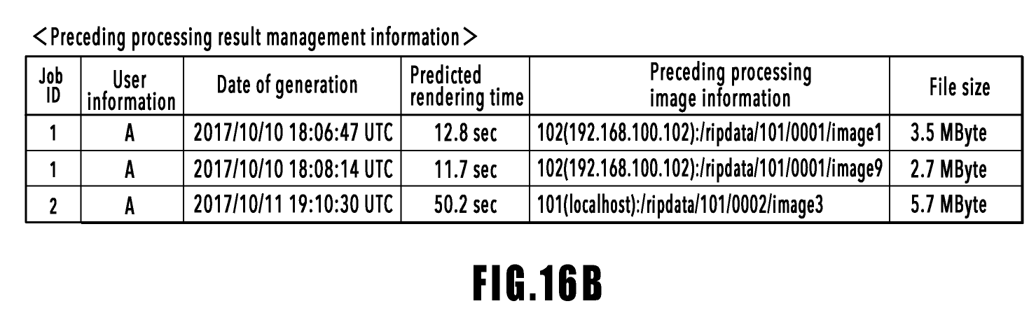

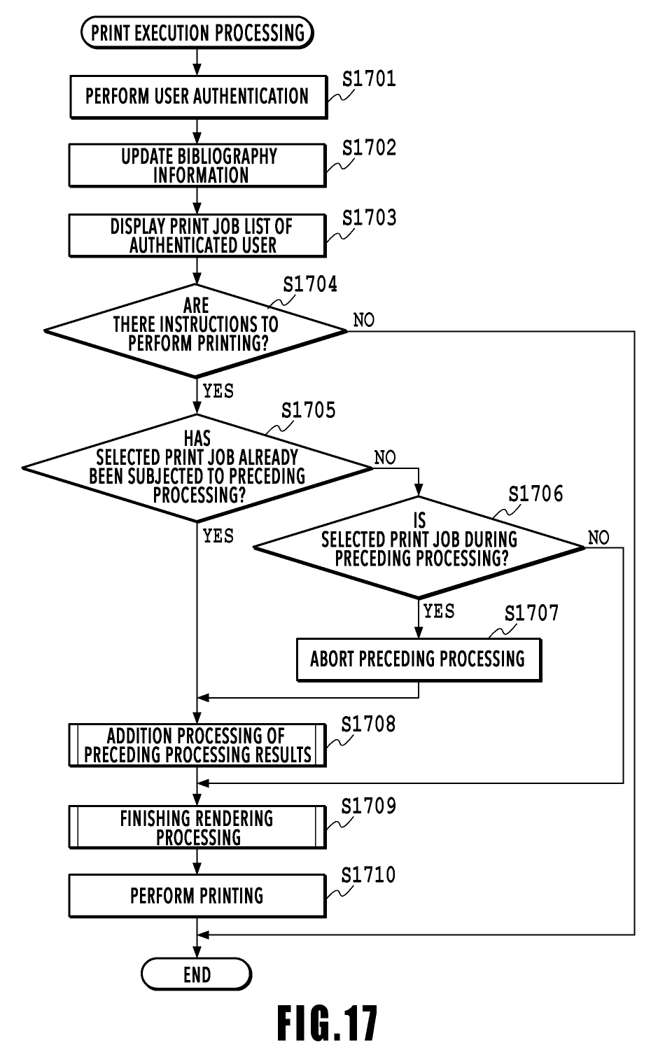

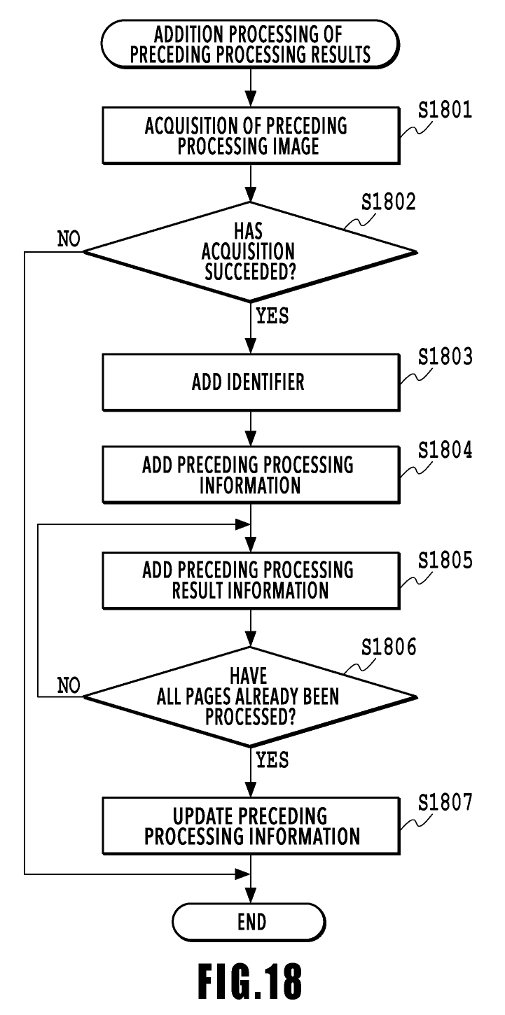

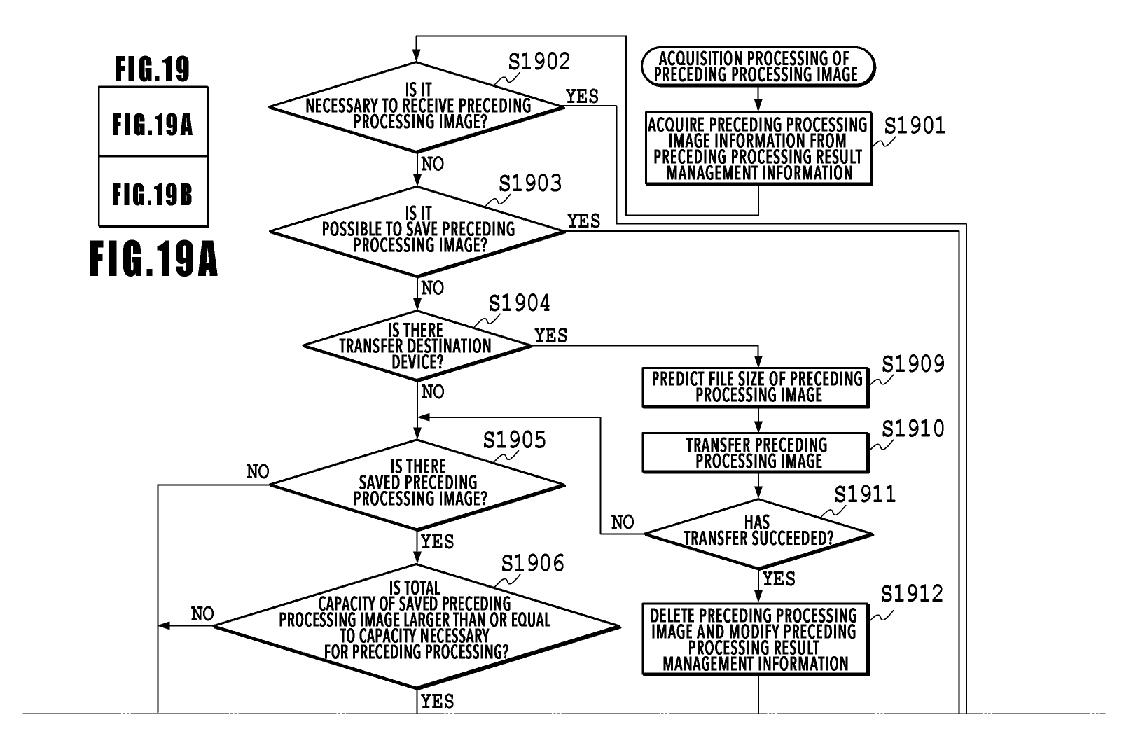

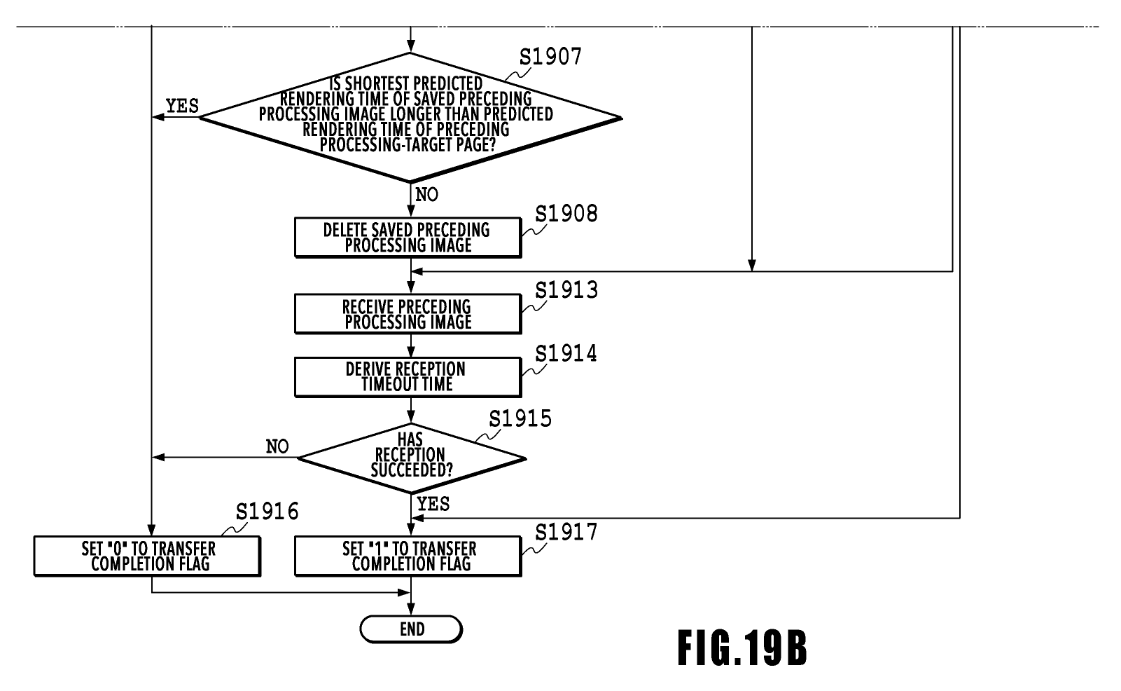

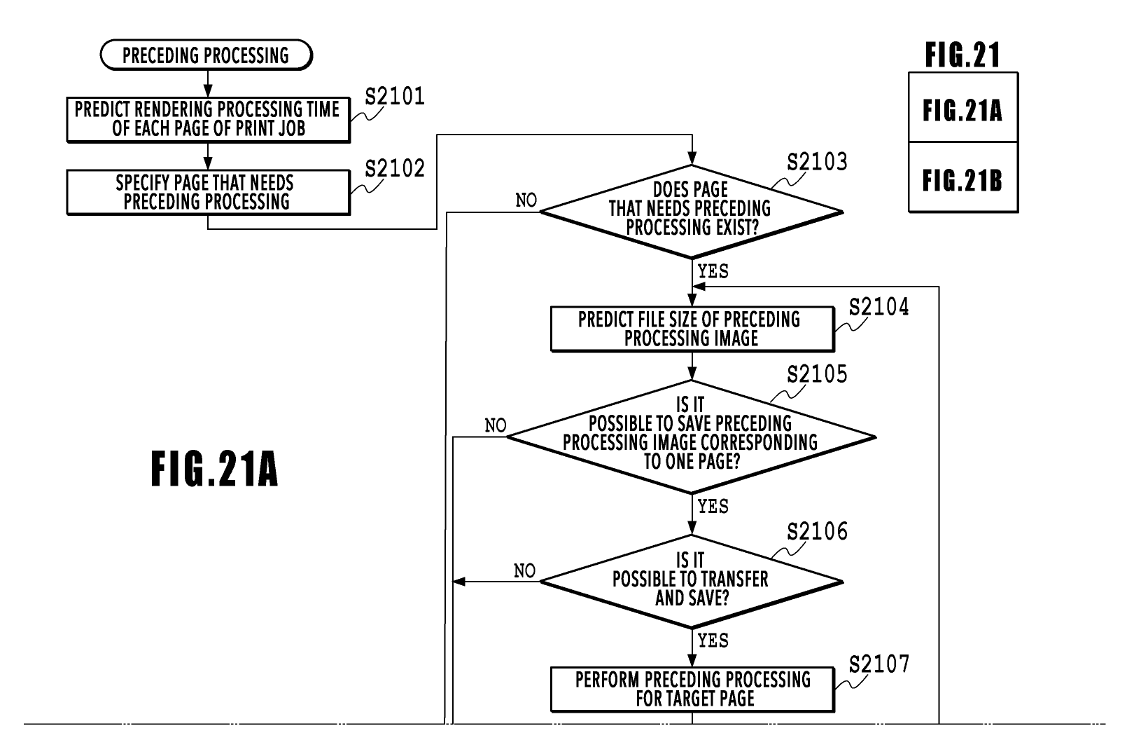

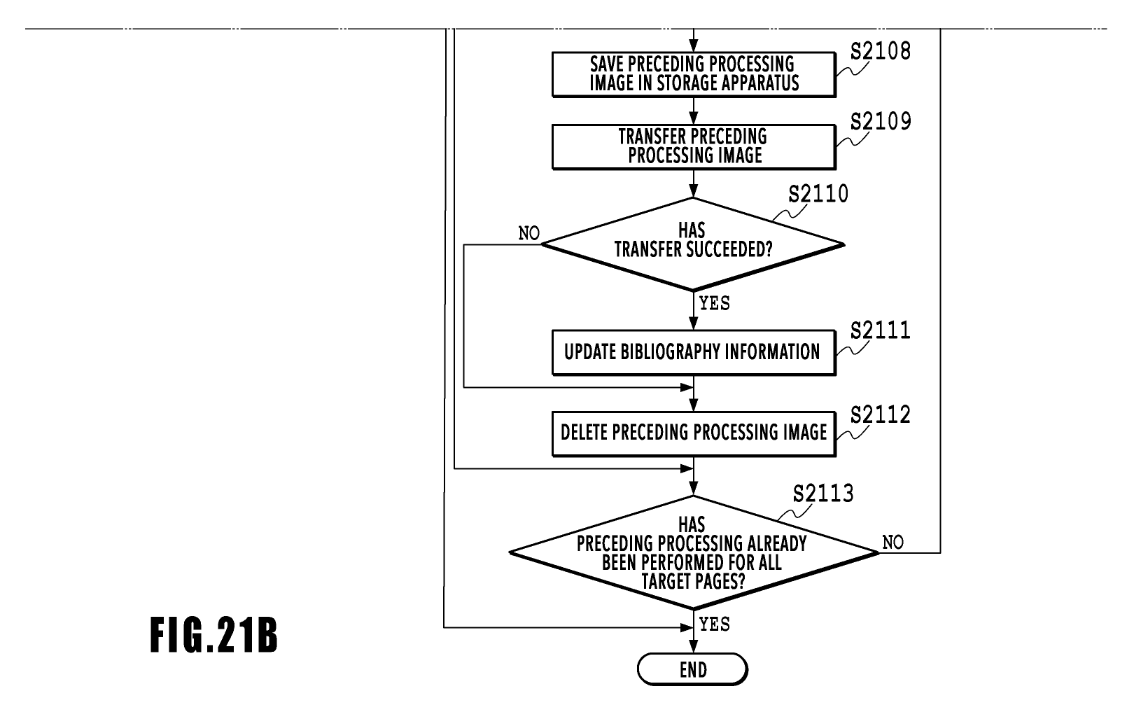

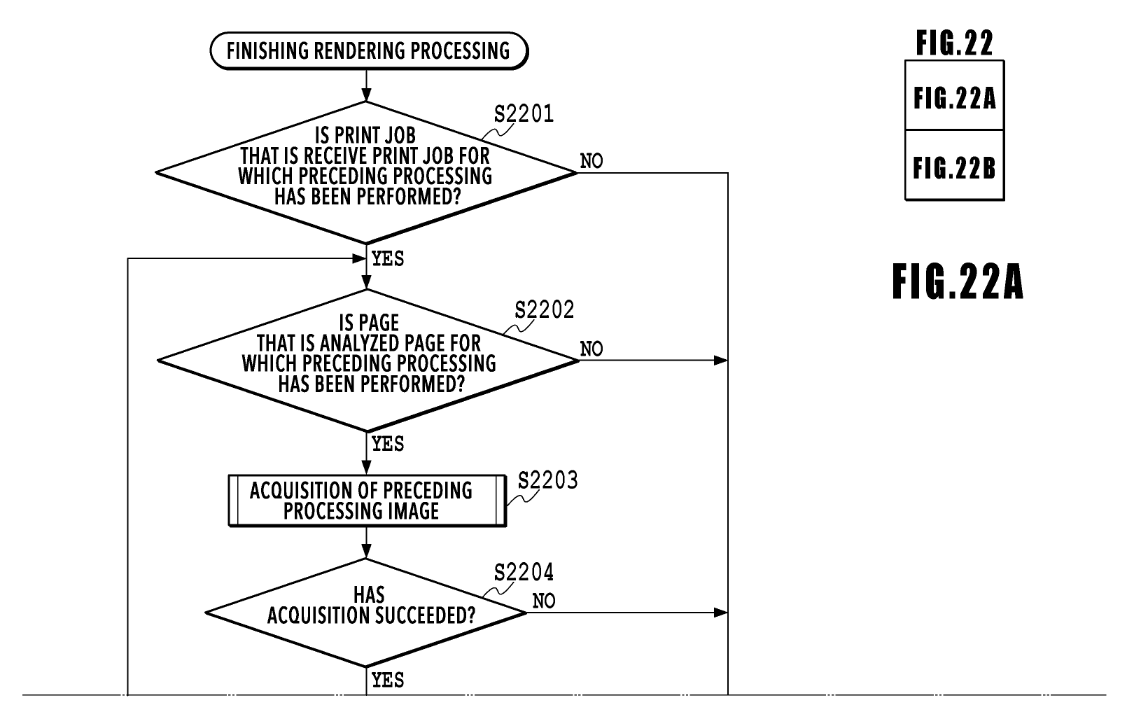

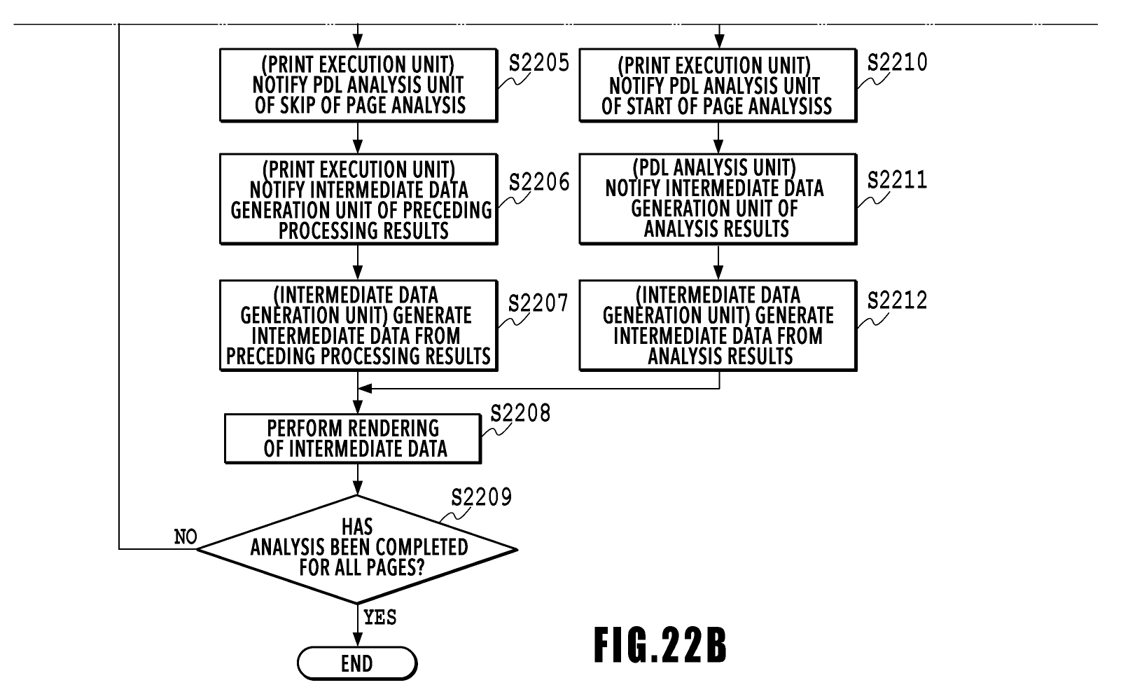

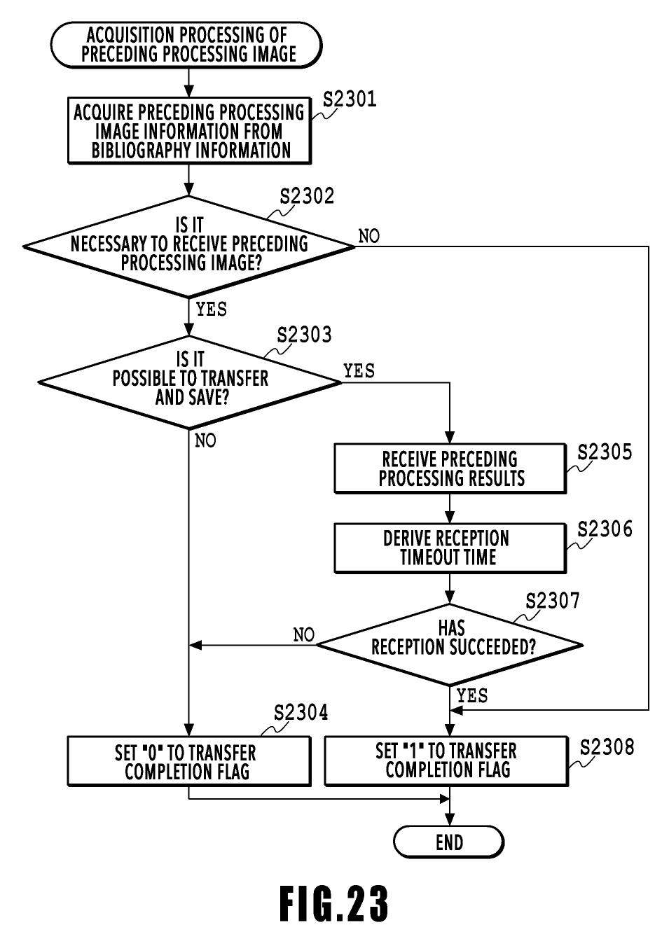

FIG. 3A to FIG. 3D are diagrams for explaining hold printing processing performed by the controller 110 included in the image forming apparatuses 101 to 103 of the first embodiment. FIG. 3A is a flowchart showing print job hold processing performed by the controller 110. FIG. 3B is a diagram for explaining a print job received by the image forming apparatus. FIG. 3C is a diagram showing bibliography information on a user A, which the controller 110 stores in the HDD 124. FIG. 3D is a diagram showing preceding processing result management information that manages results of the preceding processing. The series of processing shown in FIG. 3A is performed by the CPU 123 loading a program code stored in the ROM 126 or the like onto the RAM 125 or the like and executing the program code. This is also the same with processing shown in FIG. 4A, FIG. 5, FIG. 7, FIG. 9A, FIG. 9B, FIG. 12A-1, FIG. 12A-2, FIG. 14A-1, FIG. 14A-2, FIG. 16A-1, FIG. 16A-2, FIG. 17, FIG. 18, FIG. 19A, FIG. 19B, FIG. 21A, FIG. 21B, FIG. 22A, FIG. 22B and FIG. 23, to be described later.

First, the print control unit 134 performs reception of a print job transmitted from the PC 104 or the like through the network I/F 120 (S301). In the present embodiment, data as shown in FIG. 3B is received as a print job. As shown in FIG. 3B, in the top area of the print job, header information including various kinds of setting information is stored and following the top area, information on each page (here, PDL data) is stored. “P1”, “Line 1”, “Text 1”, and so on in FIG. 3B are examples of a drawing command for configuring a page.

Next, the print control unit 134 determines whether or not to hold the print job received at S301 (S302). The determination of whether or not to hold is performed by determining, for example, whether or not information instructing to hold the print job is included in the parameter (for example, setting information that can be changed via the operation panel 113) stored within the image forming apparatus or the header information on the print job.

In a case where printing is performed without holding the print job (No at S302), the print execution unit 138 generates intermediate data by controlling the PDL analysis unit 139 and the intermediate generation unit 140 to perform the analysis of the print job. Further, the print execution unit 138 generates image data by causing the RIP 128 to perform the rendering processing of the generated intermediate data (S303). Next, the print execution unit 138 causes the image processing circuit 129 to perform the correction processing of the image data generated at S303 (S304). Then, the print execution unit 138 transfers the image data after the correction to the print mechanism 111 through the device I/F 127 and causes the print mechanism 111 to perform printing.

On the other hand, in a case where the print job is held (Yes at S302), the hold control unit 137 acquires the user information added to the print job (S305). In the example shown in FIG. 3B, “User name: user A” corresponds to the user information. It is not required for the user information to be included in the header information on the print job and for example, a configuration may be accepted in which the PC 104, which is the source of transmission of the print job, transmits user information separately. Further, the user information may be any information, such as a user name and a user ID, as long as it is possible to identify a user who has given the print execution instructions.

Next, the job analysis unit 135 acquires print setting information and a document name included in the header information on the received print job (S306). In the print setting information, for example, information indicating one-sided printing or double-sided printing, information indicating color printing or monochrome printing, information indicating the size of a sheet to be output, and so on are included. It is not required for all the pieces of information to be included in the print setting information and it may also be possible to store a part of the information in the HDD 124 or the ROM 126 in advance as an initial setting value or it may also be possible to cause a user to specify the information at the time of performing printing.

Next, the hold control unit 137 associates the user information acquired at S305 and the print setting information acquired at S306 with each other (S307). Then, the hold control unit 137 adds information obtained by the association to the bibliography information on the corresponding user as one record. FIG. 3C shows an example of the bibliography information on user A. In the bibliography information, for example, the job ID, file information, print setting information, the number of pages, the predicted rendering time of each page, and so on are included. As the job ID, a unique value is set for each print job.

Lastly, the bibliography management unit 133 saves the bibliography information to which the record is added at S307 in the HDD 124 (S308). The hold control unit 137 saves the print job received at S301 in the HDD 124 as the print job corresponding to the record added this time. At this time, the bibliography management unit 133 adds the host names (IP addresses) and the file paths of the image forming apparatuses 101 to 103 to the bibliography information as information (file information) indicating the destination of saving of the print job saved by the hold control unit 137. In the present embodiment, as shown in FIG. 3C, file information is added in the format of “host name (IP address): /printdata/host name/job ID/file name”. FIG. 3D shows an example of the preceding processing result management information that is managed together with the bibliography information. The preceding processing result management information is information for managing the results of the preceding processing of the print job corresponding to the user information and the job ID. As shown in FIG. 3D, in the preceding processing result management information, the job ID, user information, the date of generation, the predicted rendering time, and information indicating the file size of the preceding processing image are included. Further, in the preceding processing result management information, preceding processing image information indicating the storage destination (saving destination) of the preceding processing image is included. At the point in time of bibliography information registration at S308, the predicted rendering time and the preceding processing image information are registered in the state where the predicted rendering time and the preceding processing image information are not set yet. In the examples shown in FIG. 3C and FIG. 3D, to the predicted rendering time and the preceding processing image information on the print job whose job ID is “2”, “-” indicating the unset state is set. Hereinafter, the print job whose job ID is “n” is described as job # n.

FIG. 4A to FIG. 4C are diagrams for explaining the preceding processing performed by the controller 110 included in the image forming apparatuses 101 to 103 of the first embodiment. The processing shown in FIG. 4A is performed after a print job is held in the HDD 124 by the print job hold processing shown in FIG. 3A.

First, the job analysis unit 135 predicts the time taken for the rendering processing of each page included in the print job for the print job held within the HDD 124 (S401). As the prediction method, any method may be used as long as it is possible to estimate the rendering processing time by the method, such as a method of estimating the rendering processing time from the size of the print job and a method of predicting the rendering processing time from the contents of the PLD command included within the print job. The job analysis unit 135 instructs the bibliography management unit 133 to register the prediction results of the rendering processing time to the bibliography information on the corresponding print job. FIG. 4B shows an example of the bibliography information at the point in time of the completion of the processing at S401 for job #2. By the job analysis unit 135 giving instructions to the bibliography management unit 133, the rendering processing time of each page is registered.

Next, the preceding processing unit 136 specifies a page whose rendering processing takes time of the pages included in the print job as a page that needs the preceding processing (S402). For example, in a case where the rendering processing time of each page of job #1 is predicted as shown in FIG. 4B, the preceding processing unit 136 determines pages whose rendering processing takes time as the first page and the ninth page. Similarly, in a case where the rendering processing time of each page of job #2 is predicted as shown in FIG. 4B, the preceding processing unit 136 determines a page whose rendering processing takes time as the third page. As the criterion of the determination of a page whose rendering processing takes time, it may also be possible to perform the determination in accordance with the printing speed of the image forming apparatus that performs printing or it may also be possible to perform the determination by using a threshold value (for example, ten seconds) held in advance by the preceding processing unit 136. Further, it may also be possible to determine that all the pages need the preceding processing.

In a case where a page that needs the preceding processing is not specified by the processing at S402 (No at S403), the processing is terminated. In a case where a page that needs the preceding processing is specified by the processing at S402 (Yes at S403), the image management unit 141 determines whether or not it is possible to save image data (preceding processing image) obtained by the preceding processing before performing the preceding processing (S404). For example, there is a method of determining that it is not possible to save the image data in a case where the remaining capacity of the saving area (partition) of the preceding processing image, which is provided within the HDD 124, is less than a predetermined value (for example, 100 MB). Further, for example, there is a method of determining that it is not possible to save the image data in a case where the number of saved pieces of image data is larger than or equal to an upper limit by measuring the number of saved pieces of image data in advance. Furthermore, it may also be possible to perform the above-described determination based on a plurality of conditions, such as the limit to the remaining capacity of the HDD 124 and the number of saved preceding processing images, or it may also be possible to enable setting of those conditions for each user having input the print job. At S404, whether or not the remaining capacity of the HDD 124 is less than a predetermined value is taken as a determination condition because it is necessary to secure a sufficient remaining capacity in a case where the area in which the print job is saved and the area in which the preceding processing image is saved is the same. By performing the determination such as this, it is possible to suppress a situation in which it is not possible to save a print job.

In a case where it is not possible to save the preceding processing image (No at S404), the processing advances to S409. On the other hand, in a case where it is possible to save the preceding processing image (Yes at S404), the preceding processing unit 136 performs the rendering processing (preceding processing) of the page for which it is determined that the preceding processing is necessary at S402 and generates a preceding processing image (S405). In a case where there is a plurality of pages for which it is determined that the preceding processing is necessary at S402, it may also be possible to perform the preceding processing in the order of the page of the print job, or in the order from the page whose rendering processing takes the longest time, or in the order from the page whose rendering processing takes the shortest time.

Next, the preceding processing unit 136 saves the preceding processing image generated at S406 in the HDD 124 (S406). Then, the preceding processing unit 136 determines whether the preceding processing is completed for all the pages for which it is determined that the preceding processing is necessary at S402 (S407). In a case where the preceding processing images of all the target pages are generated (Yes at S407), the processing advances to S409 and in other cases (No at S407), the preceding processing unit 136 determines whether there are instructions to perform printing for the print job for which the rendering processing is performed (S408).

In a case where there are not instructions to perform printing (No at S408), the processing returns to S404. In a case where there are instructions to perform printing (Yes at S408), the preceding processing unit 136 instructs the bibliography management unit 133 to add information relating to the preceding processing image saved at S406 described above (preceding processing image information) to the corresponding preceding processing result management information (S409).

FIG. 4C shows an example of the preceding processing result management information updated by the preceding processing unit 136 at S409. In the preceding processing result management information shown in FIG. 4C, the date of generation, the predicted rendering time, the preceding processing image information, and the file size of job #2 are in the already-set state. In a case where it is determined that it is not possible to save the preceding processing image at S404, the preceding processing is not performed for job #2, and therefore, the preceding processing result management information remains unchanged and is the same as in FIG. 3D. Further, in a case where it is determined that there are instructions to perform printing at S408, the preceding processing result management information on the pages whose preceding processing is completed at that point in time is updated and the processing is terminated.

FIG. 5 is a flowchart showing print execution processing performed by the controller 110 included in the image forming apparatuses 101 to 103 of the first embodiment. For example, in a case where a user holds his/her ID card above the card reader 112, the card reader 112 transmits the user information read from the ID card to the authentication unit 131 through the reader I/F 121. Then, the processing shown in FIG. 5 is started. In place of the method of reading user information from the ID card of a user, it may also be possible to adopt another authentication method, such as a method of performing user authentication by inputting user information and a password from the operation panel 113 or the like.

First, the authentication unit 131 performs authentication processing by using the user information received from the card reader 112 through the reader I/F 121. In a case where the user authentication has succeeded, the authentication unit 131 notifies the setting unit 132 of the user information (S501).

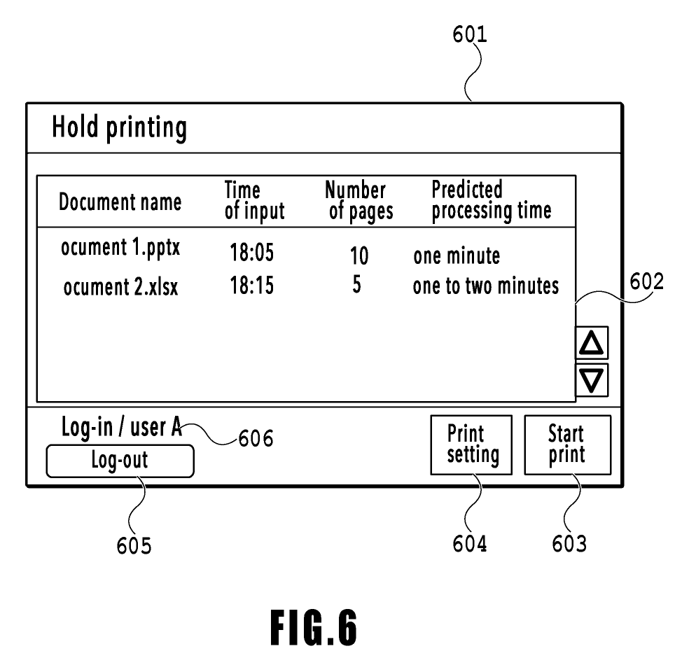

Next, the setting unit 132 receives bibliography information on the user corresponding to the user information acquired at S501 from the bibliography management unit 133 (S502). Then, the setting unit 132 displays a print job list generated based on the received bibliography information on the operation panel 113 through the panel I/F 122. A UI screen 601 that is displayed at this time is shown in FIG. 6. The UI screen 601 shown in FIG. 6 has an area 602 for displaying a print job list (hereinafter, described as a print job list 602). It is possible for a user to select a desired print job from the print job list 602 by performing the touch operation for the operation panel 113, and the like, and to give instructions to print the selected print job by pressing down a Start print button 603. Further, it is possible for a user to select a desired print job from the print job list 602 and to change the print setting of the selected print job by pressing down a Print setting button 604. A Log-out button 605 is a button for logging out from the image forming apparatus. In a case where the Log-out button 605 is pressed down, the authenticated state of a user is cancelled. In an area 606, the user information on a user who has logged in is displayed.

Next, the setting unit 132 determines whether instructions to perform printing are given by a user for the print job displayed in the print job list 602 (S503). The instructions to perform printing are input to the setting unit 132 in a case, for example, a user presses the Start print button 603. In a case where there are no instructions to perform printing (No at S503), the processing is terminated. In a case where there are instructions to perform printing (Yes at S503), the hold control unit 137 refers to the preceding processing result management information and determines whether the preceding processing has already been performed for the print job for which the instructions to perform printing are given (S504).

In a case where the preceding processing has already been performed for the print job (Yes at S504), the hold control unit 137 performs processing to add information on the preceding processing results to the PDL data (addition processing of preceding processing results (S507) and generates a print job. Details of the addition processing of preceding processing results will be described later by using FIG. 7.

In a case where the preceding processing has not been performed yet for the print job (No at S504), the hold control unit 137 refers to the preceding processing result management information and determines whether the print job for which the instructions to perform printing are given is being subjected to the preceding processing (S505). In a case where the print job is not being subjected to the preceding processing (No at S505), the processing advances to S508. In a case where the print job is being subjected to the preceding processing (Yes at S506), the hold control unit 137 aborts the preceding processing for print job being subjected to the preceding processing (S506). Information on the abort of the preceding processing is reported to the preceding processing unit 136 and is used to determine where or not there are instructions to perform printing at S408. The hold control unit 137 acquires the information on the preceding processing results saved in the HDD 124 at the point in time of the abort of the preceding processing, and advances the processing to S507 and adds the acquired information on the preceding processing results to the print job.

Next, the print execution unit 138 performs finishing rendering processing (S508). At this time, in a case where the information on the preceding processing results is not added to the processing-target print job, the same processing as that at S303 is performed. The processing in a case where the information on the preceding processing results is added to the processing-target print job will be described later by using FIG. 9A and FIG. 9B. The printing processing (S509) that is performed after S508 is the same as that at S304.

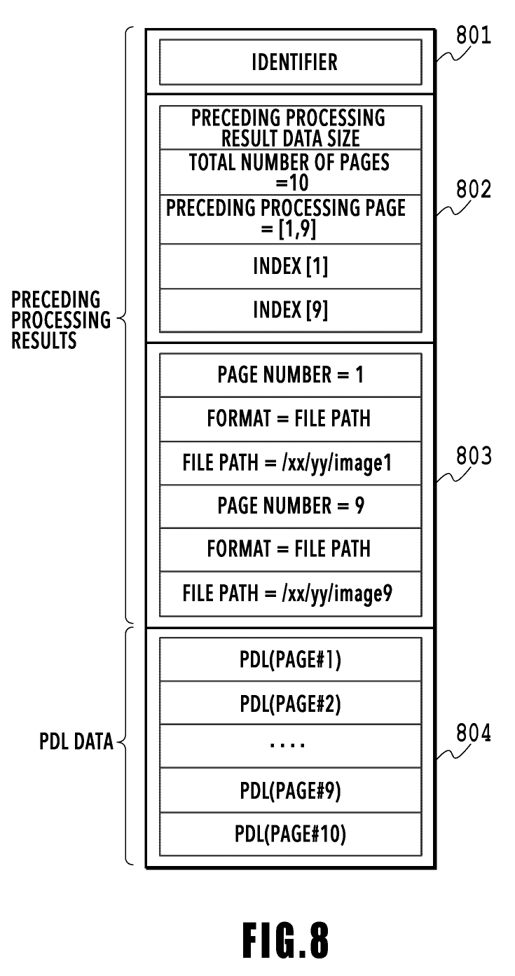

FIG. 7 is a flowchart showing the addition processing of preceding processing results performed by the controller 110 included in the image forming apparatuses 101 to 103 of the first embodiment (processing at S507 shown in FIG. 5). FIG. 8 is a diagram explaining an example of the information on the preceding processing results added to the PDL data by the addition processing of preceding processing results.

First, the hold control unit 137 adds identifier information 801 to PDL data 804 (S701). The identifier information 801 indicates whether or not a print job is a print job for which the preceding processing has been performed, that is, a print job is an already-subjected to preceding processing print job, and may be any kind of information, such as a character string and a figure, as long as it is possible to identify a print job inside the controller 110. The PDL data 804 is PDL data included in the print job received at S301 and is unprocessed PDL data.

Next, the hold control unit 137 adds preceding processing information 802 to the PDL data 804 (S702). The preceding processing information 802 includes information on the data size of entire preceding processing result information 803, the total number of pages of the processing-target print job, and the already-subjected to preceding processing page. For the information that is known after processing at S705, to be described later, is performed, such as the information on the data size of the entire preceding processing result information 803 and the already-subjected to preceding processing page, only an area for storing the information is secured and after the processing at S705, updating of the information is performed. The preceding processing information 802 shown in FIG. 8 is an example and the preceding processing information 802 may have any configuration as long as information necessary for analyzing the information on the preceding processing results is stored.

Next, the hold control unit 137 adds the preceding processing result information 803 to the PDL data 804 (S703). The preceding processing result information 803 stores page information including the number of the already-subjected to preceding processing page, information relating to the preceding processing image obtained by performing the preceding processing for the page, and information indicating the format (data format) of the information for each already-subjected to preceding processing page. In the example shown in FIG. 8, page information on the page whose page number is 1 and the page whose page number is 9 is added. Further, in the example shown in FIG. 8, information relating to the preceding processing image is added in the file path format. Hereinafter, a page whose page number is n is described as page # n.

Next, the hold control unit 137 determines whether page information has been added for all the already-subjected to preceding processing pages (S704). In a case where a page to which page information is not added exists (No at step S704), the processing returns to step S703. In a case where page information has been added for all the already-subjected to preceding processing pages (Yes at step S704), the hold control unit 137 performs updating of the preceding processing information 802 created at S702 (S705). At this time, the data size of the preceding processing result information 803, index information indicating each piece of page information, and so on are written to the area secured in advance within the preceding processing information 802. In this manner, a print job configured by the PDL data 804 and the information 801, 802, and 803 on the preceding processing results is created.

FIG. 9A and FIG. 9B are flowcharts showing an example of finishing rendering processing performed by the controller 110 included in the image forming apparatuses 101 to 103 of the first embodiment. First, the print execution unit 138 analyzes the print job received from the print control unit 134 or the hold control unit 137 and determines whether or not the identifier information 801 is included, that is, whether or not the print job is an already-subjected to preceding processing print job (S901). In a case where the identifier information 801 is not included (No at S901), the processing advances to S908. On the other hand, in a case where the identifier information 801 is included in the print job (Yes at S901), the print execution unit 138 determines whether or not information indicating that the analysis-target page has already been subjected to the preceding processing is included in the preceding processing information 802 on the print job (S902). That is, the print execution unit 138 determines whether or not the analysis-target page for which an analysis is performed from now is an already-subjected to preceding processing page. In the example shown in FIG. 8, information indicating that page #1 and page #9 are pages having already been subjected to preceding processing is included in the preceding processing information 802, and therefore, the print execution unit 138 determines that page #1 and page #9 are already-subjected to preceding processing pages. In a case where the analysis-target page is an already-subjected to preceding processing page (Yes at S902), the processing at S903 to S905 is performed. In a case where the analysis-target page is not an already-subjected to preceding processing page (No at S902), the processing at S908 to S910 is performed. Here, the processing at S903 to S905 and the processing at S908 to S910 are explained.

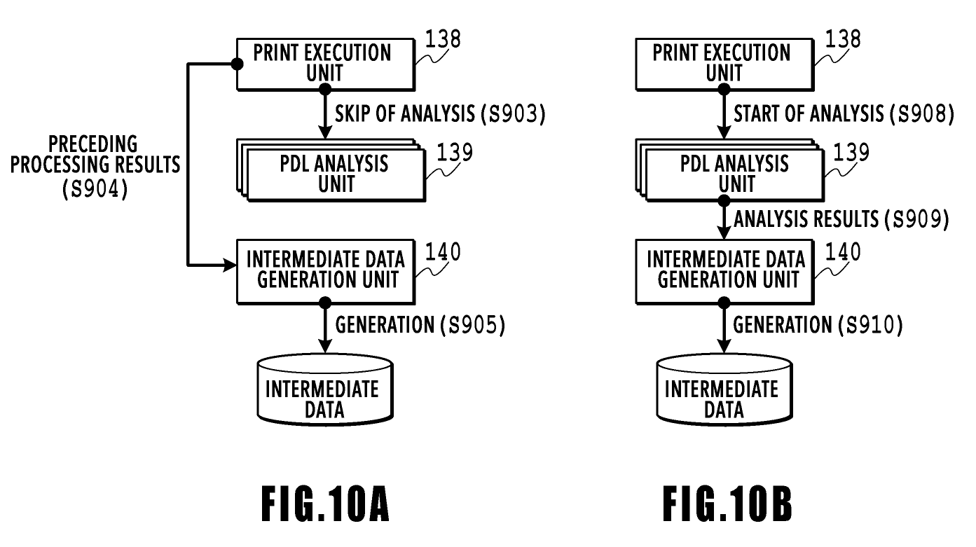

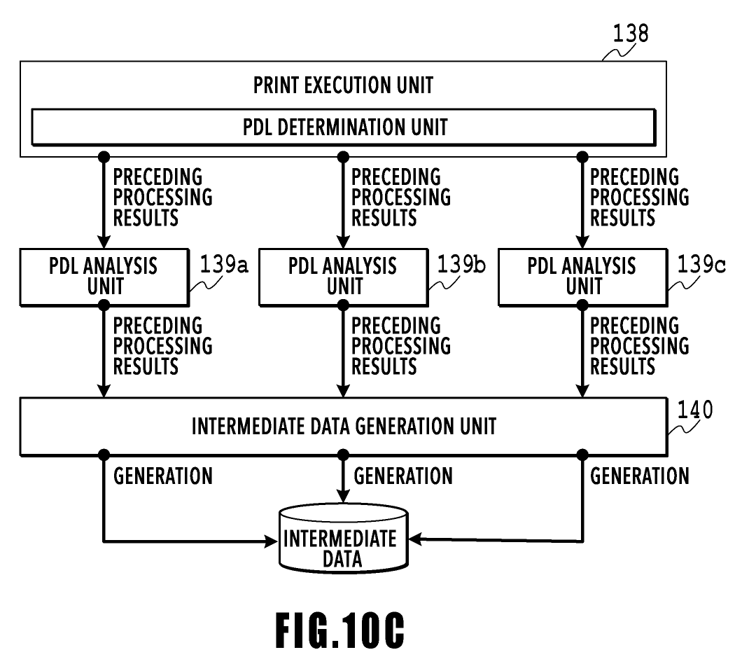

First, the processing at S903 to S905 is explained by using FIG. 10A. As shown in FIG. 10A, the print execution unit 138 notifies the PDL analysis unit 139 of a page analysis skip (S903). The PDL analysis unit 139 having received the notification of the page analysis skip skips the analysis processing for the analysis-target page and makes preparations for the analysis processing for the next analysis-target page without notifying the intermediate data generation unit 140 of anything. Next, the print execution unit 138 delivers the preceding processing results of the analysis-target page to the intermediate data generation unit 140 (S904). Specific explanation is given by using FIG. 8. In a case where the analysis-target page is page #1, the print execution unit 138 acquires information including a file path “/xx/yy/image 1” indicating the storage destination of the preceding processing image (RIP image) of page #1 from the preceding processing result information 803. Then, the print execution unit 138 notifies the intermediate data generation unit 140 of the acquired information. The intermediate data generation unit 140 generates intermediate data based on the preceding processing results notified by the print execution unit 138 (S905).

Next, the processing at S908 to S910 is explained by using FIG. 10B. As shown in FIG. 10B, the print execution unit 138 notifies the PDL analysis unit 139 of the page analysis start so as to start the analysis of the analysis-target page (S908). Then, the PDL analysis unit 139 performs the analysis of the analysis-target page and notifies the intermediate data generation unit 140 of the analysis results (S909). Then, the intermediate data generation unit 140 generates intermediate data from the analysis results of the PDL analysis unit 139 (S910).

After the processing at S905 or S910 is performed, the print execution unit 138 performs rendering of the generated intermediate data by controlling the RIP 128 (S906). At S906 after the processing at S905 is performed, the intermediate data (DL) including the preceding processing image (RIP image) is input to the RIP 128. In such a case, it is required for the RIP 128 only to deliver the input DL to the print mechanism 111 (in a case where image processing is necessary, to the image processing circuit 129). That is, by using the preceding processing image for rendering processing, it is possible to omit the complicated arithmetic operation at the time of processing the DL and to further reduce the time from the reception of the printing instructions until the start of the output (printing).

Lastly, the print execution unit 138 checks whether the analysis of all the pages of the print job has been completed (S907). In a case where the analysis of all the pages has been completed (Yes at S907), the processing is terminated. In a case where the analysis of all the pages has not been completed yet (No at S907), the processing returns to S902 and the processing for the next analysis-target page is performed continuously.

As described above, in the present embodiment, the analysis processing of an already-subjected to preceding processing page is skipped. Further, the print execution unit 138 delivers the preceding processing results to the intermediate data generation unit 140 without the interposition of the PDL analysis unit 139. Due to this, the number of processing steps is reduced, and therefore, it is possible to increase the processing speed. Further, the transmission path of the preceding processing results is simplified and the scale of the program can be reduced, and therefore, it is possible to suppress the development cost of the software module. Here, the effect obtained by the simplification of the transmission path of the preceding processing results is explained in detail by using FIG. 10C. FIG. 10C shows an example of a case where the controller 110 includes a plurality of PDL analysis units 139a , 139b , and 139c and the print execution unit 138 controls each PDL analysis unit. It is assumed that each of the PDL analysis unit 139a , 139b , and 139c analyzes LIPS (registered trademark), PS (registered trademark), and XPS (registered trademark). LIPS is an abbreviation of LBP Image Processing System. PS is an abbreviation of PostScript. XPS is an abbreviation of XML Paper Specification. It may also be possible for each PDL analysis unit to be capable of analyzing PDL other than those described above. The print execution unit 138 has a PDL determination unit configured to determine the kind of PDL data included in a print job and controls one of the PDL analysis units 139a , 139b , and 139c in accordance with the determination results. For example, the print execution unit 138 gives a necessary notification to the PDL analysis unit 139a in a case where the kind of PDL data is LIPS, to the PDL analysis unit 139b in a case where the kind of PDL data is PS, and to the PDL analysis unit 139c in a case where the kind of PDL data is XPS. However, in the configuration shown in FIG. 10C, in a case where the print execution unit 138 notifies the PDL analysis units 139a , 139b , and 139c of the preceding processing results, there arises necessity for each PDL analysis unit to further notify the intermediate data generation unit 140 of the notification. Consequently, with the configuration shown in FIG. 10C, there is a possibility that the number of processing steps increases, and therefore, the processing speed is reduced. Further, there is a possibility that the development cost of the software module is raised. Because of this, in the present embodiment, as shown in FIG. 10A, the print execution unit 138 is caused to directly notify the intermediate data generation unit 140 of the preceding processing results, and thereby, an attempt is made to increase the processing speed and to suppress the development cost. It may also be possible to implement the PDL analysis unit 139 by hardware and according to such an aspect, it is possible to further suppress the development cost of the software module.

As explained above, in the present embodiment, in the hold printing, information on preceding processing results is added to a print job at the time of execution of printing and the information on preceding processing results is used at the time of finishing rendering processing. Due to this, it is possible to reduce the wait time of a user from the printing instructions until the start of printing. Further, in the present embodiment, based on the number of saved preceding processing images that are saved and the remaining capacity of the saving area, whether or not it is possible to save the preceding processing image (S404) and in a case of determining that it is not possible to save the preceding processing image, the preceding processing is not performed. Due to this, it is possible to prevent wasteful preceding processing from being performed. That is, it is made possible to perform preceding processing efficiently in accordance with the necessity.

### Second Embodiment

In a second embodiment, an image forming apparatus that performs preceding processing different from the preceding processing explained in the first embodiment is explained. In the following, explanation of the same configuration as that of the first embodiment is omitted and points different from the first embodiment are explained mainly.

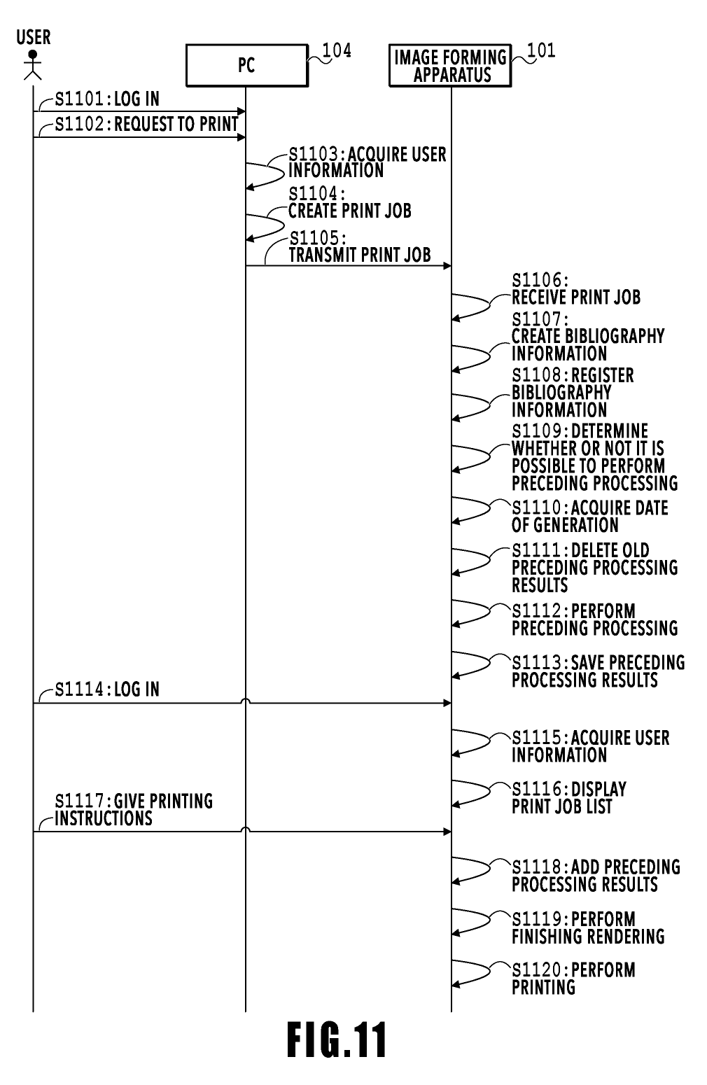

FIG. 11 is a diagram showing an example of a sequence in the second embodiment at the time of the printing system receiving a print job from the PC 104. Processing at S1101 to S1109 is the same as that at S201 to S209.

In a case of determining that it is not possible to save the image data (preceding processing image) obtained by the preceding processing in the HDD 124 in the processing at S1109, the image forming apparatus 101 acquires the date of creation of the preceding processing image saved in the HDD 124 (S1110). Then, the image forming apparatus 101 deletes the preceding processing image whose date of creation is old (S1111) and advances the processing to S1112. The processing at S1102 will be described later by using FIG. 12A-1, FIG. 12A-2 and FIG. 12B. The processing at S1113 to S1120 is the same as the processing at S211 to S218.

FIG. 12A-1, FIG. 12A-2 and FIG. 12B are diagrams for explaining the preceding processing performed by the controller 110 included in the image forming apparatuses 101 to 103 of the second embodiment. The flow shown in FIG. 12A-1 and FIG. 12A-2 is performed after a print job is held in the HDD 124 by the print job hold processing shown in FIG. 3A, as in the case with the flow shown in FIG. 4A. In the following, a case is taken as an example where the print job shown in FIG. 3B is received at S301 and the bibliography information and the preceding processing result management information are in the states shown in FIG. 3C and FIG. 3D, respectively. The processing at S1201 to S1204 is the same as the processing at S401 to S404.

In a case of determining that it is not possible to save the preceding processing image at S1204 (No at S1204), the image management unit 141 determines whether there is a saved preceding processing image that can be deleted (S1205). In the following, a saved preceding processing image that can be deleted is called simply a saved preceding processing image. At this time, it may also be possible to search for a saved preceding processing image based on the bibliography information as shown in FIG. 3C or to determine whether or not there is a saved preceding processing image by referring to the preceding processing result management information as shown in FIG. 3D. In a case where there is no saved preceding processing image (No at S1205), the processing is terminated. The case where there is no saved preceding processing image is, for example, a case where the HDD 124 is occupied by a large number of input print jobs or functions other than the preceding processing, and therefore, no preceding processing image exists in the HDD 124. In a case where there is a saved preceding processing image (Yes at S1205), the image management unit 141 deletes the preceding processing image whose date of generation is the oldest (S1206). For example, in the example shown in FIG. 3D, the date of generation of the preceding processing image of page #1 of job #1 is the oldest, and therefore, the preceding processing image of job #1 is deleted preferentially from the HDD 124. At this time, for simplification of the processing, the preceding processing image is deleted in units of jobs. That is, the preceding processing images of pages #1 and #9 of job #1 are deleted. It may also be possible to delete the preceding processing image in units of pages. Further, in place of deleting the preceding processing image whose date of generation is the oldest from all the preceding processing images registered in the preceding processing result management information, it may also be possible to delete the preceding processing image whose date of generation is the oldest for each piece of user information.

The processing at S1207 to S1210 is the same as the processing at S405 to S408. After S1210, the preceding processing unit 136 updates the preceding processing result management information on the page deleted at S1206 as well as updating the preceding processing result management information on the page for which the preceding processing has been performed at S1207 (S1211). For example, in a case where the bibliography information on the job #2 is in the state shown in FIG. 4B, at S1211, the preceding processing result management information shown in FIG. 3D is updated to the state shown in FIG. 12B. In the example shown in FIG. 12B, the dates of generation of pages #1 and #9 of job #1 and the preceding processing image information are in the state of not being set, and therefore, it is known that they are deleted. Further, it is known that information on page #3 of job #2 is set.

As above, in the present embodiment, in a case where it is not possible to save the preceding processing image within the HDD 124, the preceding processing image is deleted from the preceding processing image whose date of generation is the oldest and a new preceding processing image is saved within the HDD 124. As described above, in the present embodiment, the preceding processing image selected based on a predetermined rule that takes usability into consideration is deleted, and therefore, it is made possible to secure an empty capacity for saving a new preceding processing image without reducing usability. Further, due to this, even in a case where there is not a sufficient empty capacity in the HDD 124, it is possible to perform preceding processing, and therefore, it is made possible to save a new preceding processing image generated by the preceding processing.

### Third Embodiment

In a third embodiment, an image forming apparatus that performs preceding processing different from the preceding processing explained in the first embodiment and the second embodiment is explained. In the following, explanation of the same configuration as that of the first embodiment and the second embodiment is omitted and points different from those embodiments are explained mainly.

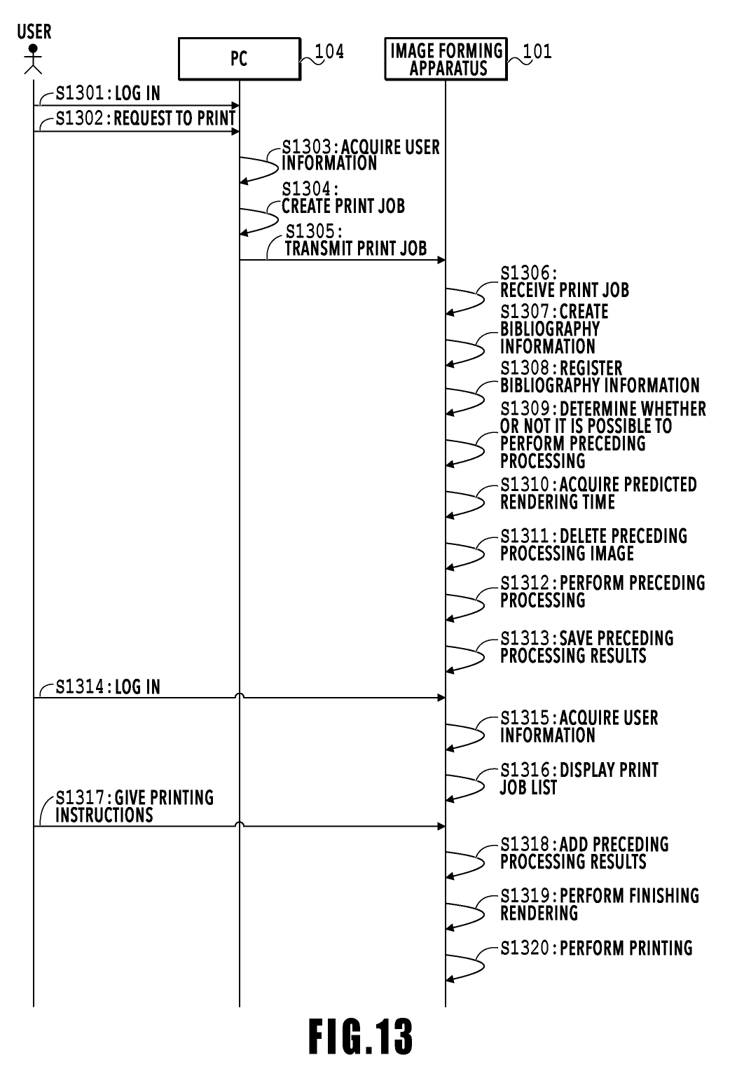

FIG. 13 is a diagram showing an example of a sequence in the third embodiment at the time of the printing system receiving a print job from the PC 104. Processing at S1301 to S1309 is the same as the processing at S1101 to S1109.

In a case of determining that it is not possible to save the image data (preceding processing image) obtained by the preceding processing in the HDD 124 in the processing at S1309, the image forming apparatus 101 acquires the predicted rendering time of the preceding processing image saved in the HDD 124 (S1309). Then, the image forming apparatus 101 preferentially deletes the preceding processing image whose predicted rendering time is short of the preceding processing images saved in the HDD 124 (S1311) and advances the processing to S1312 (preceding processing). The processing at S1312 will be described later by using FIG. 14A-1, FIG. 14A-2 and FIG. 14B. The processing at S1312 to S1320 is the same as the processing at S1112 to S1120.

FIG. 14A-1, FIG. 14A-2 and FIG. 14B are diagrams for explaining the preceding processing performed by the controller 110 included in the image forming apparatuses 101 to 103 of the third embodiment. The flow shown in FIG. 14A-1 and FIG. 14A-2 is performed after a print job is held in the HDD 124 by the print job hold processing shown in FIG. 3A, as in the case with the flow shown in FIG. 4A. In the following, a case is taken as an example where the print job shown in FIG. 3B is received at S301 and the bibliography information and the preceding processing result management information are in the states shown in FIG. 3 and FIG. 3C, respectively. The processing at S1401 to S1404 is the same as the processing at S1201 to S1204.

After the processing at S1404, the image management unit 141 determines whether there is a saved preceding processing image (S1405). In a case where there is no saved preceding processing image (No at S1405), the processing advances to S1413. In a case where there is a saved preceding processing image (Yes at S1405), the image management unit 141 acquires the predicted rendering time of each saved preceding processing image. Further, the image management unit 141 selects the saved preceding processing image whose predicted rendering time is the shortest of the saved preceding processing images (S1406). For example, in the example shown in FIG. 3D, the predicted rendering time of page #9 of job #1 is the shortest, and therefore, the preceding processing image of page #9 of job #1 is selected. Here, in place of selecting the preceding processing image whose predicted rendering time is the shortest from all the preceding processing images registered in the preceding processing result management information, it may also be possible to select the preceding processing image whose predicted rendering time is the shortest for each piece of user information. The image management unit 141 determines whether or not the predicted rendering time of the preceding processing-target page is longer than the predicted rendering time of the saved preceding processing image selected at S1406 (S1407). In a case where the predicted rendering time of the preceding processing-target page is longer (Yes at S1407), the image management unit 141 determines that it is better to perform the preceding processing anew and deletes the saved preceding processing image selected at S1406 (S1408). In the other cases (No at S1407), the image management unit 141 determines that it is better not to perform the preceding processing anew and advances the processing to S1411.

As above, in the present embodiment, in a case where it is not possible to save the preceding processing results within the HDD 124, the saved preceding processing image whose predicted rendering time is short is deleted and a preceding processing image generated anew is saved within the HDD 124. Because of this, it is made possible to preferentially save the preceding processing image capable of reducing the wait time of a user more in the HDD 124. Further, in a case where a saved preceding processing image whose predicted rendering time is shorter than that of the preceding processing-target page does not exist, it is determined that the necessity to perform the preceding processing for the preceding processing-target page does not exist, and thus, the preceding processing is not performed. Consequently, it is possible to prevent wasteful preceding processing from being performed.

### Fourth Embodiment

In a fourth embodiment, an image forming apparatus that performs preceding processing different from the preceding processing explained in the first embodiment, the second embodiment, and the third embodiment is explained. In the following, explanation of the same configuration as that of the first embodiment, the second embodiment, and the third embodiment is omitted and points different from those embodiments are explained mainly.

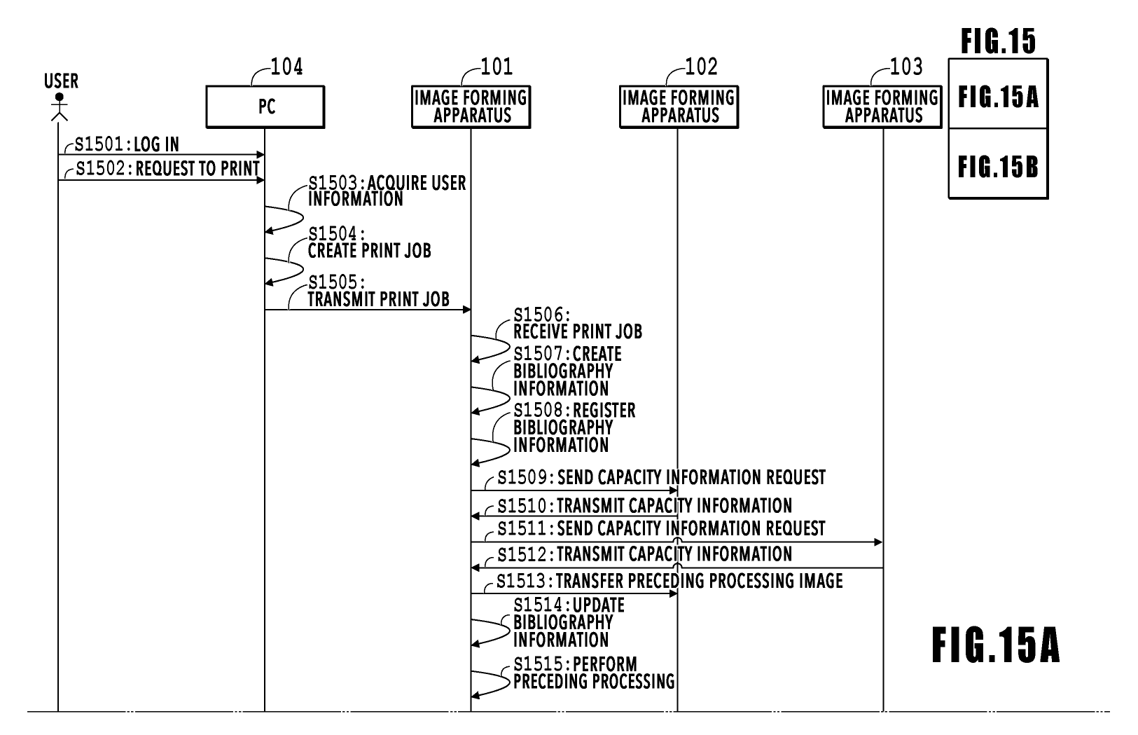

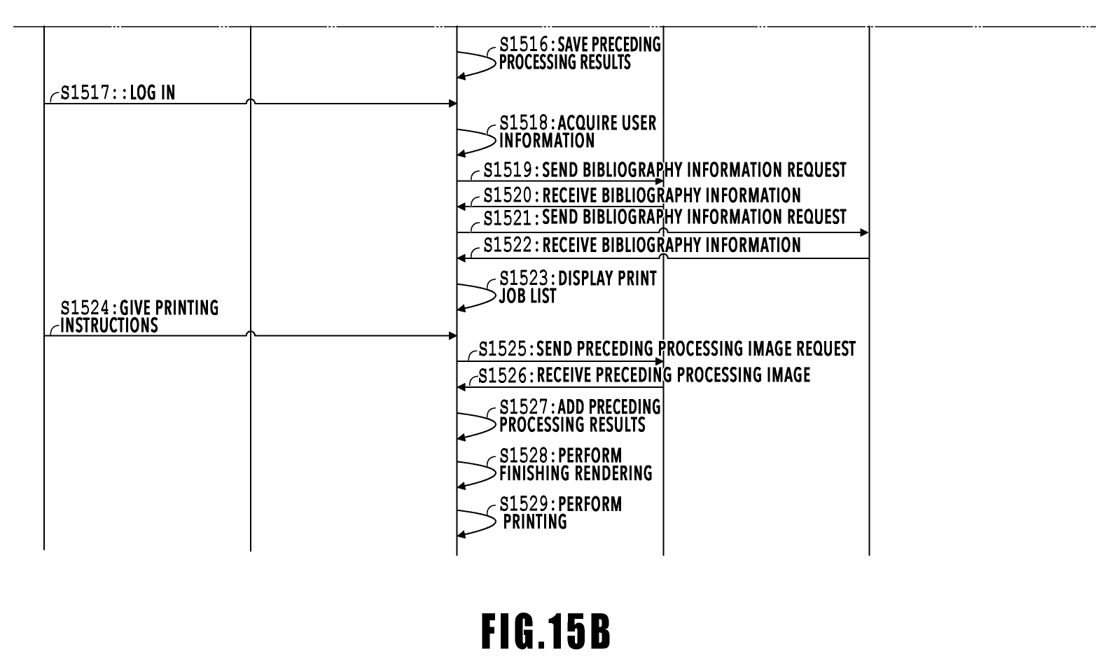

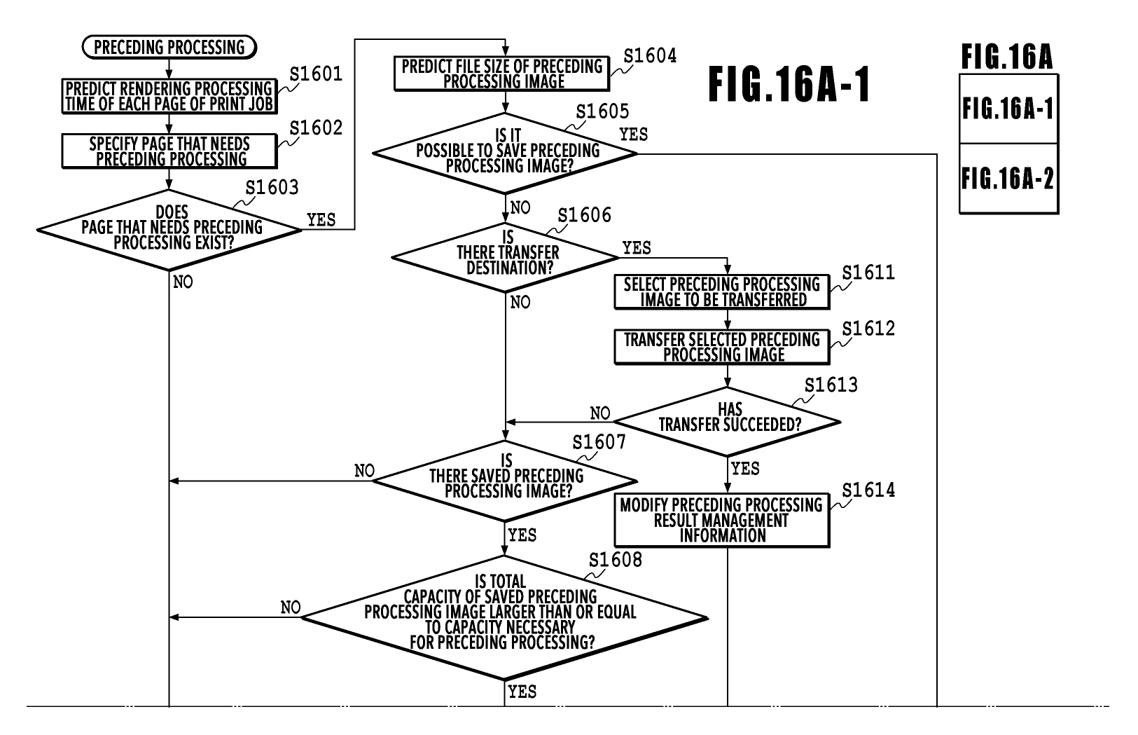

FIG. 15A and FIG. 15B are diagrams showing an example of a sequence in the fourth embodiment at the time of the printing system receiving a print job from the PC 104. Processing at S1501 to S1308 is the same as the processing at S201 to S208.

After registering bibliography information at S1508, the image forming apparatus 101 checks the empty capacities of the HDD 124 within the image forming apparatus 101 and the storage apparatuses within the image forming apparatuses 102 and 103 (S1509 to S1512). More specifically, in a case of determining that there is not a sufficient empty capacity for saving the preceding processing image in the HDD 124, the image forming apparatus 101 sends a capacity information acquisition request to the image forming apparatuses 102 and 103 (S1509, S1511). In response to the capacity information acquisition request from the image forming apparatus 101, the image forming apparatuses 102 and 103 transmit information (capacity information) indicating the empty capacities of the storage apparatuses of the image forming apparatuses 102 and 103 (S1510, S1512). The image forming apparatus 101 determines whether or not it is possible to transfer the preceding processing image to the storage apparatuses of the image forming apparatuses 102 and 103 based on the received capacity information. In a case of determining that it is possible to transfer the preceding processing image, the image forming apparatus 101 transfers the preceding processing image saved within the HDD 124 in units of jobs to another image forming apparatus (S1513).

In a case where the transfer has succeeded, the image forming apparatus 101 updates the bibliography information on the print job corresponding to the transferred preceding processing image (S1514). Then, the image forming apparatus 101 starts the preceding processing of the print data received anew (S1515) and saves the preceding processing image obtained by performing the preceding processing in the HDD 124 (S1516).

In a case where a user logs in to the image forming apparatus 101 (S1517), the image forming apparatus 101 acquires user information input by the user at the time of log-in (S1518). Then, the image forming apparatus 101 requests the other image forming apparatuses 102 and 103 on the LAN 105 to transmit bibliography information (S1519, S1521). Upon receipt of the bibliography information from each image forming apparatus (S1520, S522), the image forming apparatus 101 displays a print job list corresponding to the user information acquired at S1518 on the operation panel 113 (S1523). The image forming apparatus 101 receives printing instructions from the user (S1524). Then, the image forming apparatus 101 receives the preceding processing image saved in the HDD 124 or the preceding processing image from the other image forming apparatus (here, image forming apparatus 102), which is recorded in the bibliography information (S1525, S1526) and adds the preceding processing image to the print job (S1517). The image forming apparatus 101 performs finishing rendering processing by using the preceding processing image added to the print job (S1728) and performs printing (S1729).

FIG. 16A-1, FIG. 16A-2 and FIG. 16B are diagrams for explaining the preceding processing performed by the controller 110 included in the image forming apparatuses 101 to 103 of the fourth embodiment. The flow shown in FIG. 16A-1 and FIG. 16A-2 is performed after a print job is held in the HDD 124 by the print job hold processing shown in FIG. 3A, as in the case with the flow shown in FIG. 4A. The processing at S1601 to S1603 is the same as the processing at S401 to S403.

In a case where it is determined that a page that needs preceding processing does not exist (No at S1603) as a result of the processing at S1602, the processing advances to S1618. In this case, the processing is terminated without the preceding processing result management information being updated at S1618. On the other hand, in a case where it is determined that a page that needs preceding processing exists (Yes at S1603), the image management unit 141 determines whether or not it is possible to save the image data (preceding processing image) obtained by preceding processing before the preceding processing is performed (S1604, S1605). First, at S1604, the image management unit 141 predicts the file size of the preceding processing image based on the print setting information saved in the bibliography information and the number of pages needing preceding processing specified at S1602. At this time, the image management unit 141 acquires print setting values, such as the sheet size, the output resolution, and the color mode, from the print setting information saved in the bibliography information and finds the width, the height, and the number of channels of the preceding processing image from those setting values. Then, the image management unit 141 predicts the average value or the maximum value of the file size, which is derived from the image with the same conditions as the found conditions, as the file size of the preceding processing image. It may also be possible to predict the file size by another prediction method. Next, the image management unit 141 determines whether or not it is possible to save the preceding processing image in the HDD 124 based on the prediction results at S1604 and the empty capacity of the HDD 124 (S1605). In a case where it is possible to save the preceding processing image (Yes at S1605), the processing advances to S1615. In a case where it is not possible to save the preceding processing image (No at S1605), the image management unit 141 determines whether it is possible to transfer the preceding processing image saved in the HDD 124 to another image forming apparatus (S1606). At this time, the image management unit 141 makes an inquiry to the image forming apparatus 102 and the image forming apparatus 103 about the empty capacity of the storage apparatus (for example, HDD). This processing corresponds to the processing at S1509 to S1512 described above. In a case where there is not an empty capacity larger than or equal to the file size predicted at S1604 in any storage apparatus of the image forming apparatuses, the image management unit 141 determines that it is not possible to transfer the preceding processing image (No at S1606) and the image management unit 141 advances the processing to S1607 to S1610. On the other hand, in a case where there is an empty capacity larger than or equal to the file size, the image management unit 141 determines that it is possible to transfer the preceding processing image (Yes at S1606) and advances the processing to S1611 to S1614. Here, the example is shown in which the determination at S1606 is performed by using the file size predicted at S1604 as a threshold value, but it may also be possible to use a value obtained by providing a predetermined margin for the file size as a threshold value.

First, the processing at S1607 to S1610 is explained. The image management unit 141 determines whether or not a saved preceding processing image exists within the HDD 124 (S1607). In a case where no saved preceding processing image exists (No at S1607), the processing advances to S1618. In a case where a saved preceding processing image exists (Yes at S1607), the image management unit 141 determines whether or not the total capacity of the saved preceding processing image is larger than or equal to the file size predicted at S1604 (S1608). In a case where the total capacity is less than the file size predicted at S1604 (No at S1608), the processing advances to S1618. In the other cases (Yes at S1608), the image management unit 141 determines whether or not the shortest predicted rendering time of the predicted rendering times of the saved preceding processing images is longer than the predicted rendering time of the preceding processing-target page (S1609). In a case where the shortest predicted rendering time is longer than the predicted rendering time of the preceding processing-target page (Yes at S1609), the processing advances to S1618. In the other cases (No at S1609), the image management unit 141 deletes the preceding processing images that can be deleted from the HDD 124 by a capacity corresponding to the necessary size (S1610) and advances the processing to S1615. For example, it is assume that the bibliography information on print job #2 at the time of execution at S1605 is in the state shown in FIG. 4B, the preceding processing result management information is in the state shown in FIG. 3D, and the file size predicted at S1604 is 5 MB. Further, it is assumed that there is no empty capacity of 5 MB or more in the storage apparatuses of the image forming apparatuses 102 and 103. In this case, the image management unit 141 determines that it is necessary to delete the preceding processing image of print job #1 saved within the HDD 124 in order to secure an empty capacity of 5 MB or more (S1605, S1606). Further, each of the predicted rendering times of pages #1 and #9 of print job #1 does not exceed the predicted rendering time of the page (page #3) of print job #2, which needs the preceding processing. Because of this, the image management unit 141 deletes the preceding processing image corresponding to print job #1 (S1610). At this time, it may also be possible to compare the total of the predicted rendering times of page #1 and page #9 of print job #2 with the predicted rendering time of the page (page #3) of print job #2, which needs the preceding processing. Further, in a case where the file size predicted at S1604 is 3 MB, it is possible to secure a necessary empty capacity by deleting only the preceding processing image of page #9 of print job #1. However, in the present embodiment, it is assumed that the saved preceding processing image is deleted in units of jobs for simplification of processing.

Next, the processing at S1611 to S1614 is explained. The processing at S1611 to S1614 corresponds to the processing at S1509 to S1513 in FIG. 15A. At S1611, the image management unit 141 selects a preceding processing image that is transferred to another image forming apparatus. The preceding processing image that is transferred is a preceding processing image from the generation of which a predetermined time elapses and whose predicted rendering time is long. At S1612, the image management unit 141 transfers the preceding processing image selected at S1611. At this time, the image management unit 141 does not transfer the PDL data, which is the generation source of the preceding processing image, and transfers only the preceding processing image. In a case where the transfer has succeeded (Yes at S1613), the image management unit 141 modifies the preceding processing result management information (S1614) and advances the processing to S1615. In a case where the transfer has succeeded, the area within the HDD 124, in which the transferred preceding processing image was stored, becomes an unused area. In a case where the transfer has failed for some reason (No at S1613), the processing advances to S1607. For example, it is assumed that in a case where the bibliography information on print job #1 at the time of execution at S1611 is in the state shown in FIG. 3D, at S1612 and S1613, the transfer of each preceding processing image of print job #1 is performed and further, the preceding processing of print job #2 is performed. In such a case, the preceding processing result management information enters the state shown in FIG. 16B. In FIG. 16B, the top directory of the storage destination of print job #1 is updated to “102 (192. 168. 100. 102)” representing the host name and the IP address of the image forming apparatus 102.

The processing at S1615 and S1616 is the same as the processing at S405 and S406. After S1616, the preceding processing unit 136 determines whether the preceding processing has been completed for all the pages for which it is determined that the preceding processing is necessary at S1602 (S1617). In a case where the preceding processing has been completed for all the pages (Yes at S1617), the processing advances to S1618. Then, after the preceding processing result management information is updated at S1618, the processing is terminated. In a case where the preceding processing has not been completed for all the pages (No at S1617), the processing advances to S1619.

At S1619, the preceding processing unit 136 checks whether there are no instructions to perform printing for the print job for which the preceding processing has been performed and whether there remains a sufficient capacity in the HDD 124 for saving the preceding processing image obtained by performing the preceding processing for the remaining pages, which are the preceding processing target. In a case where there are no instructions to perform printing and there is a sufficient empty capacity in the HDD 124 (Yes at S1619), the processing returns to S1615 and the preceding processing is performed for the remaining pages, which are the preceding processing target. In a case where there are instructions to perform printing or in a case where there is not a sufficient empty capacity in the HDD 124 (No at S1619), the processing advances to S1618. Then, at S1618, after the preceding processing result management information is updated, the processing is terminated. According to the determination processing at S1619, it is possible to suppress unnecessary preceding processing from being performed at S1615 in a case where a print job is sent anew from a user during preceding processing, or in a case where the prediction at S1604 is not correct.

FIG. 17 is a flowchart showing an example of print execution processing performed by the controller 110 included in the image forming apparatuses 101 to 103 of the fourth embodiment. The authentication unit 131 performs authentication processing (S1701). This processing is the same as the processing at S501. After S1701, the bibliography management unit 133 updates the bibliography information (S1702). Specifically, the bibliography management unit 133 makes an inquiry to the image forming apparatuses (here, the image forming apparatuses 102 and 103) on the LAN 105 about the bibliography information on a print job input to the image forming apparatuses. The bibliography management units of the image forming apparatuses 102 and 103 on the LAN 105 send the bibliography information on the jobs input to the image forming apparatuses 102 and 103 to the bibliography management unit 133 of the image forming apparatus 101. Due to this, it is possible for the bibliography management unit 133 to receive the print jobs held by the image forming apparatuses 102 and 103 on the LAN and information relating to the predicted rendering times of the print jobs, the storage destinations of the transferred preceding processing images, and so on. Further, the bibliography management unit 133 compares the bibliography information received from the image forming apparatuses 102 and 103 on the LAN 105 with the bibliography information held internally. In a case of determining that the print job held in the image forming apparatuses 102 and 103 is deleted based on the comparison results, the bibliography management unit 133 deletes information relating to the print job, which is managed within the image forming apparatus 101.

The processing at S1703 to S1710 is the same as the processing at S502 to S509. However, the processing at S1708 is different from the processing at S507. In the following, the difference is explained by using FIG. 18.

FIG. 18 is a flowchart showing an example of addition processing (processing at S1706 shown in FIG. 17) of preceding processing results, which is performed by the controller 110 included in the image forming apparatuses 101 to 103 of the fourth embodiment.

First, the hold control unit 137 acquires a preceding processing image by using the image management unit 141 (S1801). The processing at S1801 will be described in detail by using FIG. 19A and FIG. 19B. In a case where the preceding processing image is located in another image forming apparatus, the hold control unit 137 requests the other image forming apparatus to transfer the preceding processing image. In a case where the preceding processing image is located within the image forming apparatus, the hold control unit 137 refers to the file path described in the bibliography information and acquires the preceding processing image.

Next, the hold control unit 137 refers to a transfer completion flag, to be described later, and determines whether it has been possible to acquire the preceding processing image (S1802). In a case where the transfer completion flag is “completed (1)” (Yes at S1802), the hold control unit 137 determines that it has been possible to acquire the preceding processing image and advances the processing to S1803. On the other hand, in a case where the transfer completion flag is “uncompleted (0)” (No at S1802), the hold control unit 137 determines that the acquisition of the preceding processing image has failed and terminates the processing. The processing at S1803 to S1807 is the same as the processing at S701 to S705.

As described above, in a case where the acquisition of the preceding processing image has failed, by skipping the processing at S1803 to S1807, additional information is prevented from being included in the print job. Due to this, even in a case where the acquisition of the preceding processing image has failed for an already-subjected to preceding processing print job, it is possible to process the print job as a print job for which the preceding processing has not been performed in the finishing rendering processing (processing shown in FIG. 9A and FIG. 9B).

FIG. 19A and FIG. 19B are flowcharts showing an example of acquisition processing (processing at S1801 shown in FIG. 18) of the preceding processing image performed by the controller 110 included in the image forming apparatus 102 and 103 of the fourth embodiment.

First, the image management unit 141 acquires information relating to a preceding processing image, such as a storage destination, from the preceding processing result management information (S1901). Next, the image management unit 141 determines whether the preceding processing image is stored in another image forming apparatus on the LAN 105, that is, whether it is necessary to receive the preceding processing image from another image forming apparatus (S1902). In a case where reception is not necessary (No at S1902), the image management unit 141 sets the transfer completion flag for the preceding processing image, for which it has been determined that reception is not necessary, to “completed” (S1917) and terminates the processing. In a case where reception is necessary (Yes at S1902), the image management unit 141 determines whether it is possible to save the preceding processing image in the HDD 124 in a case where the preceding processing image stored in another image forming apparatus is received (S1903). That is, the image management unit 141 determines whether there remains a sufficient empty capacity for saving the received preceding processing image in the HDD 124. In a case where there remains a sufficient empty capacity (Yes at S1903), the image management unit 141 starts reception processing for receiving the preceding processing image from another image forming apparatus (S1913). In a case where there remains no sufficient empty capacity (No at S1903), the image management unit 141 performs processing at S1904 to S1912 for securing the capacity of the HDD 124 so as to make it possible to save the preceding processing image received from another image forming apparatus. The processing at S1904 to S1912 is the same as the processing at S1605 to S1614. However, in a case where the determination results of the processing at 1905, S1906, and S1907 are negative, the image management unit 141 sets the transfer completion flag to “uncompleted” (S1916) and terminates the processing. Further, after the processing at S1908, the image management unit 141 advances the processing to S1913.

After S1913, the image management unit 141 derives a timeout time (hereinafter, called reception timeout time) of the reception processing (S1914). The reception timeout time is set so that, for example, the total of the time taken for receiving a preceding processing image and time required until the completion of discharge of a printing medium of the print job performed by using the preceding processing image does not exceed the predicted rendering time of the bibliography information. The image management unit 141 determines whether the reception of the preceding processing image has been completed within the reception timeout time (S1915). In a case where the reception processing has not been completed within the reception timeout time, or in a case where connection with the image forming apparatus storing the preceding processing image is not established (No at S1915), the image management unit 141 determines that the reception processing has failed. Then, the image management unit 141 sets the transfer completion flag to “uncompleted” (S1916) and terminates the processing. In a case where the reception processing has been completed within the reception timeout time (Yes at S1915), the image management unit 141 sets the transfer completion flag to “completed” (S1917) and terminates the processing.

As above, in the present embodiment, in a case where it is not possible to save a preceding processing image in the HDD 124, the preceding processing image is not deleted but transferred to another image forming apparatus. Consequently, according to the present embodiment, even in a case where there is not a sufficient empty capacity in the HDD 124, it is made possible to use a preceding processing image in the finishing rendering processing. Further, in the present embodiment, in a case where it is not possible to transfer a preceding processing image to another image forming apparatus, as in the third embodiment, a preceding processing image whose predicted rendering time is short is deleted and a preceding processing image generated anew is saved in the HDD 124. Consequently, even in a case where it is not possible to transfer a preceding processing image to another image forming apparatus and a saved preceding processing image is deleted, it is possible to preferentially keep a preceding processing image capable of reducing the wait time of a user more in the HDD 124.

In the present embodiment, at S1609 and S1907, a delete target is selected from the saved preceding processing images based on the predicted rendering time, but it may also be possible to select a preceding processing image whose date of generation is the oldest as a delete target as in the second embodiment.

### Fifth Embodiment

In the fourth embodiment, the image forming apparatus that performs transfer and delete of a preceding processing image in units of jobs before execution of preceding processing is explained. However, depending on the capacity of a storage apparatus, such as an HDD, possessed by the image forming apparatus, there is a case where it is no longer possible to perform preceding processing because it is not possible to hold the preceding processing image in units of jobs. For example, a case where a large number of held print jobs are input, a case where the capacity of the storage apparatus is occupied by the functions possessed by another image forming apparatus, or the like. Consequently, in the present embodiment, transfer of a preceding processing image is performed in units of pages. Due to this, even in a case where there is not a sufficient empty capacity in the storage apparatus within the image forming apparatus, it is made possible to perform preceding processing and to hold a preceding processing image.

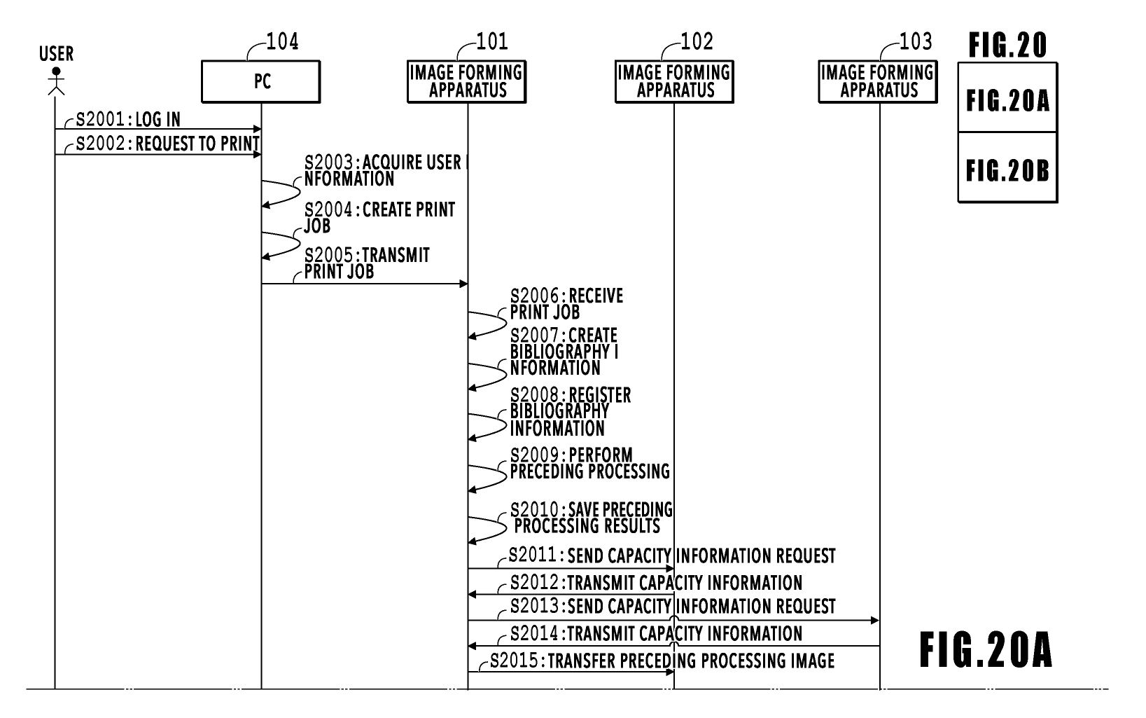

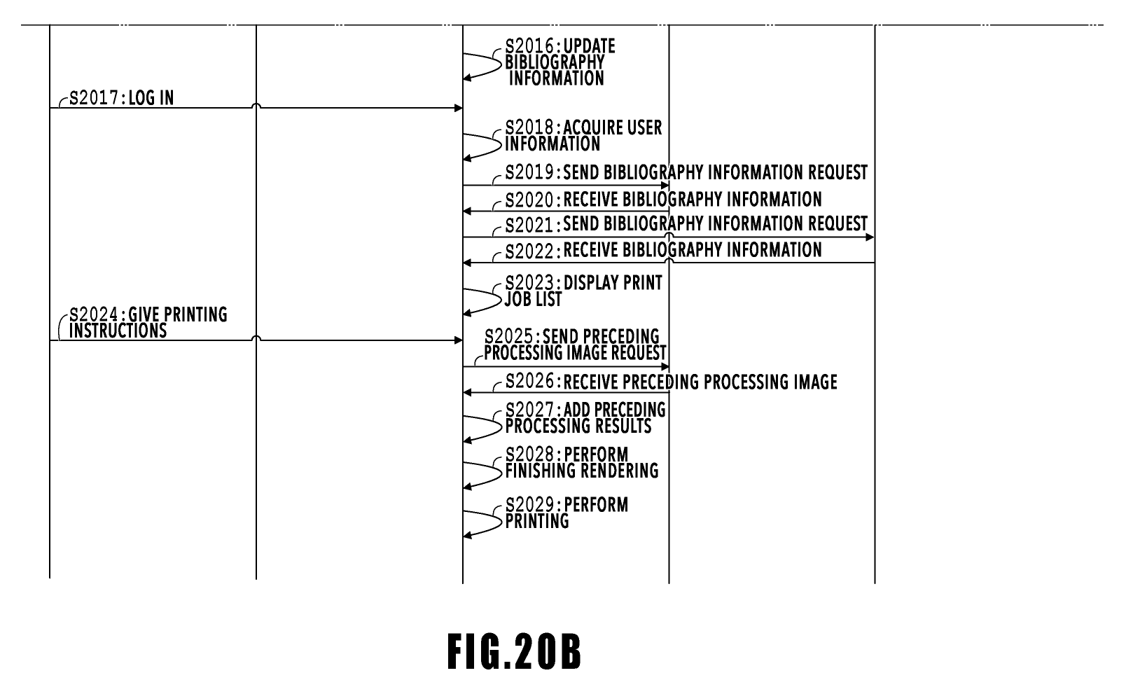

The configuration of the printing system and the image forming apparatus in the fifth embodiment is the same as that in FIG. 1. FIG. 20A and FIG. 20B are diagrams showing an example of a sequence in the fifth embodiment at the time of the printing system receiving a print job from the PC 104. The processing at S2001 to S2008 is the same as the processing at S201 to S208.

After registering bibliography information at S2008, the image forming apparatus 101 starts preceding processing corresponding one page for the print data (S2009). The preceding processing image generated by the preceding processing is saved in the HDD 124 (S2010). After this, the image forming apparatus 101 checks the empty capacities of the storage apparatuses within the image forming apparatuses 102 and 103 (S2011 to S2014)). The processing at S2011 to S2014 is the same as that at S1509 to S1512. Based on the capacity information received at S2012 and S2014, the image forming apparatus 101 determines which of the image forming apparatuses 102 and 103 is taken to be the transfer destination of the preceding processing image corresponding to one page generated at S2010 and transfers the preceding processing image to the determined transfer destination (S2015). In a case where the transfer has succeeded, the image forming apparatus 101 updates of the bibliography information on the print job corresponding to the transferred preceding processing image (S2016). The processing at S2017 to S2023 is the same as the processing at S1717 to S1723.

The image forming apparatus 101 receives printing instructions from a user (S2024). Then, the image forming apparatus 101 receives a preceding processing image corresponding to one page recorded in the bibliography information from another image forming apparatus (here, the image forming apparatus 102) (S2025, S2026) and adds the preceding processing image to the print job (S2027). The image forming apparatus 101 performs the finishing rendering processing by using the preceding processing image added to the print job (S2028) and performs printing (S2029).

As above, in the present embodiment, the preceding processing and the transfer of a preceding processing image are performed for each page and a preceding processing image is received from the transfer destination for each page at the time of the finishing rendering processing. Details of the processing are explained by using FIG. 21 to FIG. 23.

FIG. 21 is a flowchart showing an example of preceding processing performed by the controller 110 included in the image forming apparatuses 101 to 103 of the fifth embodiment. The flow shown in FIG. 21 is performed after a print job is held in the HDD 124 by the print job hold processing shown in FIG. 3A, as in the case with the flow shown in FIG. 4A. The processing at S2101 to S2103 is the same as that at S1601 to S1603.

In a case where it is determined that pages that need preceding processing exist at S2103 (Yes at S2103), the image management unit 141 selects one page from those pages and predicts the file size of the preceding processing image for the selected page (S2104). As the prediction method of the file size, it may also be possible to use the same prediction method as that of the fourth embodiment, or to use another method. Next, the image management unit 141 determines whether or not it is possible to save the preceding processing image corresponding to the one page selected at S2104 in the HDD 124 (S2105). In a case where saving is not possible (No at S2105), the processing advances to S2113. In a case where saving is possible (Yes at S2105), the image management unit 141 determines whether it is possible to transfer the preceding processing image corresponding to the one page predicted at S2104 to another image forming apparatus (S2106). At this time, the image management unit 141 makes an inquiry to the image forming apparatus 102 and the image forming apparatus 103 about the empty capacity of the storage apparatus (for example, HDD). In a case where there is not an empty capacity larger than or equal to the file size predicted at S2104 in any storage apparatus of the image forming apparatuses, it is determined that transfer of the preceding processing image is not possible (No at S2106) and the processing advances to S2113. In a case where it is determined that transfer of the preceding processing image is possible (Yes at S2106), the preceding processing unit 136 performs preceding processing for the page selected at S2104 and generates a preceding processing image of the page (S2107). Here, the example in which the file size predicted at S2104 is used as a determination criterion is shown, but it may also be possible to take a value obtained by providing a predetermined margin for the file size as a determination criterion. After S2107, the preceding processing unit 136 temporarily stores the generated preceding processing image in the HDD 124 (S2108). The image management unit 141 transfers the preceding processing image temporarily saved in the HDD 124 to another image forming apparatus (S2109) and further determines whether or not the transfer has succeeded (S2110). In a case where the transfer has succeeded (Yes at S2110), the image management unit 141 updates the bibliography information (S2111) and deletes the preceding processing image saved temporarily in the HDD 124 at S2108 (S2112). In a case where the transfer has failed (No at S2110), the image management unit 141 does not perform the processing at S2111 but performs the processing at S2112.

At S2113, the preceding processing unit 136 determines whether the preceding processing has been completed for all the pages for which it is determined that preceding processing is necessary at S2102. In a case where the preceding processing has been performed for all the pages (Yes at S2113), the processing is terminated. In a case where the preceding processing has not been completed yet for all the pages (No at S2113), the processing returns to S2104.

Next, the print execution processing after user authentication performed by the controller 110 included in the image forming apparatuses 101 to 103 of the fifth embodiment is explained. The print execution processing in the present embodiment is the same as the print execution processing in the fourth embodiment shown in FIG. 17. However, in the present embodiment, the preceding processing image transferred to another image forming apparatus is received in units of pages at the time of the finishing rendering processing, and therefor, the addition processing of preceding processing results and the finishing rendering processing are different from those of the fourth embodiment. The addition processing of preceding processing results is performed in accordance with the flow shown in FIG. 7 as in the first embodiment, and therefore, explanation is omitted.

FIG. 22A and FIG. 22B are flowcharts showing an example of the finishing rendering processing performed by the controller 110 included in the image forming apparatuses 101 to 103 of the fifth embodiment. The processing at S2201 and S2205 to S2212 is the same as the processing at S901 and S903 to 910.

After S2201, the print execution unit 138 determines whether or not an analysis-target page to be analyzed from now is a page for which preceding processing has been performed (S2202). In a case where the analysis-target page is not a page for which preceding processing has been performed (No at S2202), the processing advances to S2210. In a case where the analysis-target page is a page for which preceding processing has been performed (Yes at S2202), the print execution unit 138 performs acquisition of the preceding processing image by using the image management unit 141 (S2203). Here, processing at S2203 is explained by using FIG. 23.

FIG. 23 is a flowchart showing an example of acquisition processing (processing at S2203 shown in FIG. 22A and FIG. 22B) of a preceding processing image performed by the controller 110 included in the image forming apparatuses 101 to 103 of the fifth embodiment. First, the image management unit 141 acquires information (saving destination and the like) relating to the preceding processing image from bibliography information (S2301). Next, the image management unit 141 determines whether a preceding processing image is stored in another image forming apparatus on the LAN 105, that is, whether it is necessary to receive a preceding processing image from another image forming apparatus (S2302). In a case where reception is not necessary (No at S2302), the image management unit 141 sets the transfer completion flag for the preceding processing image, for which it has been determined that reception is necessary, to “completed” (S2308) and terminates the processing. In a case where reception is necessary (Yes at S2302), the image management unit 141 determines whether it is possible to save the preceding processing image in the HDD 124 in a case of receiving the preceding processing image stored in another image forming apparatus (S2303). That is, the image management unit 141 determines whether there remains a sufficient empty capacity for saving the received preceding processing image in the HDD 124. In a case where remains no sufficient empty capacity (No at S2303), the image management unit 141 sets the transfer completion flag to “uncompleted” (S2304) and terminates the processing. In a case where there remains a sufficient empty capacity (Yes at S2303), the image management unit 141 starts reception processing for receiving the preceding processing image from another image forming apparatus (S2305).

Next, the image management unit 141 derives a reception timeout time (S2306). This processing is the same as that at S1914, and therefore, explanation is omitted. Next, the image management unit 141 determines whether the reception of the preceding processing image has been completed within the reception timeout time (S2307). In a case where the reception processing has not been completed within the reception timeout time, or in a case where connection with the image forming apparatus storing the preceding processing image is not established (No at S2307), the image management unit 141 determines that the reception processing has failed. Then, the image management unit 141 sets the transfer completion flag to “uncompleted” (S2304) and terminates the processing. In a case where the reception processing has been completed within the reception timeout time (Yes at S2307), the image management unit 141 sets the transfer completion flag to “completed” (S2308) and terminates the processing.

Explanation is returned to the flow in FIG. 22A and FIG. 22B. After the processing at S2203, the hold control unit 137 refers to the transfer completion flag set by the image management unit 141 and determines whether it has been possible to acquire the preceding processing image (S2204). In a case where the transfer completion flag is “completed” (Yes at S2204), the processing advances to S2205 and in a case where the transfer completion flag is “uncompleted” (No at S2204), the processing advances to S2210.

As above, according to the present embodiment, by performing transfer of a preceding processing image in units of pages, even in a case where there is not a sufficient empty capacity in the HDD 124, it is made possible to perform preceding processing and to hold a preceding processing image. It may also be possible to transfer or delete a saved preceding processing image within the HDD 124 as in the fourth embodiment in place of the processing at S2105 and S2106 or in addition to the processing. Then, it may also be possible to perform processing at S2107 and subsequent steps by securing an empty capacity capable of saving a preceding processing image corresponding to one page.

As the embodiments of the present invention, a variety of embodiments are considered other than those described above. For example, an embodiment combining a plurality of embodiments is in the category of the present invention. Further, it is also possible to combine each element of each embodiment in a possible range.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present invention, it is possible to efficiently perform preceding rendering processing performed before printing instructions in accordance with the necessity in hold printing.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-072497 filed Apr. 4, 2018, which is hereby incorporated by reference wherein in its entirety.

What is claimed is:

1. An image forming apparatus capable of performing hold printing in which a received print job is held and printing of a held print job is performed in accordance with printing instructions from a user, the image forming apparatus comprising:
one or more memories storing instructions; and
one or more processors which is capable of executing the instructions causing the image forming apparatus to:
perform preceding processing to perform in advance rendering for image data of the held print job before reception of printing instructions;
save a rendering image generated by the preceding processing in a storage apparatus; and
determine whether or not it is possible to save a new rendering image in the storage apparatus before the preceding processing is performed, wherein
whether or not to perform the preceding processing is determined in accordance with determination results.

2. The image forming apparatus according to claim 1, wherein
the preceding processing is performed in a case where it is determined that saving is possible.

3. The image forming apparatus according to claim 1, wherein
it is determined that it is not possible to save the new rendering image in the storage apparatus in a case where a remaining capacity of a rendering image saving area in the storage apparatus is less than a predetermined value.

4. The image forming apparatus according to claim 1, wherein
it is determined that it is not possible to save the new rendering image in the storage apparatus in a case where a number of saved rendering images stored in the storage apparatus is larger than or equal to an upper limit value determined in advance.

5. The image forming apparatus according to claim 1, wherein
the preceding processing is performed after securing an unused area for saving the new rendering image by deleting a rendering image selected based on a predetermined rule from the storage apparatus in a case where it is determined that saving is not possible.

6. The image forming apparatus according to claim 1, wherein
the preceding processing is performed after securing an unused area for saving the new rendering image by transferring a rendering image selected based on a predetermined rule from the storage apparatus to another image forming apparatus in a case where it is determined that saving is not possible.

7. The image forming apparatus according to claim 6, wherein
the preceding processing is performed after securing an unused area for saving the new rendering image by deleting a rendering image selected based on the predetermined rule from the storage apparatus in a case where the transfer has failed.

8. The image forming apparatus according to claim 6, wherein, in a case of receiving instructions to print a print job corresponding to one rendering image transferred to the other image forming apparatus of the held print jobs, the one rendering image is acquired from the other image forming apparatus and is delivered the acquired one rendering image to a printing unit configured to perform printing.

9. The image forming apparatus according to claim 8, the instructions further cause the image forming apparatus to:
determine whether or not it is possible to save the one rendering image in the storage apparatus before the one rendering image is acquired from the other image forming apparatus, wherein
the one rendering image is acquired from the other image forming apparatus in a case where it is determined that saving is possible.

10. The image forming apparatus according to claim 9, wherein
the one rendering image is acquired from the other image forming apparatus after securing an unused area for saving the one rendering image by deleting a rendering image selected based on the predetermined rule from the storage apparatus in a case where it is determined that saving is not possible.

11. The image forming apparatus according to claim 9, wherein
the one rendering image is acquired from the other image forming apparatus after securing an unused area for saving the one rendering image by transferring a rendering image selected based on the predetermined rule from the storage apparatus to the other image forming apparatus or another image forming apparatus different from the other image forming apparatus in a case where it is determined that saving is not possible.

12. The image forming apparatus according to claim 6, wherein
the preceding processing and transferring of a rendering image are performed in units of pages.

13. The image forming apparatus according to claim 5, wherein
the predetermined rule is a rule of preferentially selecting a rendering image from among rendering images saved in the storage apparatus in order from a rendering image whose date of generation is old.

14. The image forming apparatus according to claim 5, wherein
the predetermined rule is a rule of preferentially selecting a rendering image from among rendering images saved in the storage apparatus in order from a rendering image whose predicted rendering time is short.

15. The image forming apparatus according to claim 14, wherein
the preceding processing is not performed in a case where the predicted rendering time of the new rendering image is shorter than that of the selected rendering image.

16. A control method of an image forming apparatus capable of performing hold printing in which a received print job is held and printing of a held print job is performed in accordance with printing instructions from a user, the method comprising the steps of:
performing preceding processing to perform in advance rendering for image data of the held print job before reception of printing instructions; and
saving a rendering image generated by the preceding processing in a storage apparatus, wherein
whether or not it is possible to save a new rendering image in the storage apparatus is determined before the preceding processing is performed and whether or not to perform the preceding processing is determined in accordance with results of the determination.

17. A non-transitory computer readable storage medium storing a program for causing a computer to perform a control method of an image forming apparatus capable of performing hold printing in which a received print job is held and printing of a held print job is performed in accordance with printing instructions from a user, the method comprising the steps of:
performing preceding processing to perform in advance rendering for image data of the held print job before reception of printing instructions; and
saving a rendering image generated by the preceding processing in a storage apparatus, wherein
whether or not it is possible to save a new rendering image in the storage apparatus is determined before the preceding processing is performed and whether or not to perform the preceding processing is determined in accordance with results of the determination.
